(19) United States
(12) Patent Application Publication
(10) Pub. No.: US 2026/0313370 A1
(43) Pub. Date: Oct. 8, 2026

(54) APPARATUS AND METHOD FOR SHARING ENCRYPTED DATA IN WIRELESS COMMUNICATION SYSTEM

(71) Applicant: LG ELECTRONICS INC., Seoul (KR)

(72) Inventors: Soonhee KWON, Seoul (KR); Sangrim LEE, Seoul (KR)

(73) Assignee: LG ELECTRONICS INC., Seoul (KR)

(21) Appl. No.: 19/472,431

(22) PCT Filed: Apr. 5, 2023
(86) PCT No.: PCT/KR2023/004578

§ 371 Date: Oct. 3, 2025

(51) Int. Cl. H04W 12/037

(52) U.S. Cl. CPC H04W 12/037

(57) ABSTRACT

The purpose of the present disclosure is to share encrypted data in a wireless communication system. An operation method of a first device may comprise the steps of: receiving, from a second device, a first message requesting capability information of the first device; transmitting, to the second device, a second message including the capability information of the first device; performing control signaling with the second device; and transmitting data on the basis of the control signaling.

### CROSS-REFERENCE TO RELATED APPLICATION(S)

This application is the National Stage filing under 35 U.S.C. 371 of International Application No. PCT/KR2023/004578, filed on Apr. 5, 2023, the contents of which are all incorporated by reference herein in its entirety.

### TECHNICAL FIELD

The following description relates to a wireless communication system, including a method for sharing encrypted data in the wireless communication system, and a device supporting the same.

### BACKGROUND

Radio access systems have come into widespread in order to provide various types of communication services such as voice or data. In general, a radio access system is a multiple access system capable of supporting communication with multiple users by sharing available system resources (bandwidth, transmit power, etc.). Examples of the multiple access system include a code division multiple access (CDMA) system, a frequency division multiple access (FDMA) system, a time division multiple access (TDMA) system, a single carrier-frequency division multiple access (SC-FDMA) system, etc.

In particular, as many communication devices require a large communication capacity, an enhanced mobile broadband (eMBB) communication technology has been proposed compared to radio access technology (RAT). In addition, not only massive machine type communications (MTC) for providing various services anytime anywhere by connecting a plurality of devices and things but also communication systems considering services/user equipments (UEs) sensitive to reliability and latency have been proposed. To this end, various technical configurations have been proposed.

### SUMMARY

The present disclosure may provide a method for effectively sharing encrypted data in a wireless communication system and a device supporting the same.

The present disclosure may provide a method for effectively managing data shared between multiple entities in a wireless communication system and a device supporting the same.

The present disclosure may provide a method initializing settings related to sharing and encryption of data in a wireless communication system and a device supporting the same.

The present disclosure may provide a method for uploading encrypted data based on homomorphic encryption in a wireless communication system and a device supporting the same.

The present disclosure may provide a method for downloading encrypted data based on homomorphic encryption in a wireless communication system and a device supporting the same.

The present disclosure may provide a method for performing key refreshing related to encrypted data based on homomorphic encryption in a wireless communication system and a device supporting the same.

The present disclosure may provide a method for accessing encrypted data by group based on homomorphic encryption in a wireless communication system and a device supporting the same.

The present disclosure may provide a method for changing member of a group sharing data encrypted based on homomorphic encryption in a wireless communication system and a device supporting the same.

The present disclosure may provide a method for merging groups sharing data encrypted based on homomorphic encryption in a wireless communication system and a device supporting the same.

The present disclosure may provide a method for dividing a group sharing data encrypted based on homomorphic encryption in a wireless communication system and a device supporting the same.

The technical objects to be achieved in the present disclosure are not limited to the above-mentioned technical objects, and other technical objects that are not mentioned may be considered by those skilled in the art through the embodiment(s) described below.

As an example of the present disclosure, provided is a method performed by a first device in a wireless communication system. The method may comprise: receiving, from a second device, a first message requesting capability information of the first device; transmitting, to the second device, a second message including capability information of the first device; performing control signaling with the second device; and transmitting data based on the control signaling, wherein the data or a message transmitted through the control signaling, as information for a key refreshing procedure for a data sharing service based on homomorphic encryption, includes a secret key of the first device encrypted by using a first reference public key based on public keys of updated members and is used to convert data encrypted by using a second reference public key determined before the key refreshing procedure into data encrypted by using the first reference public key.

As an example of the present disclosure, provided is a method performed by a second device in a wireless communication system. The method may comprise: transmitting, to a first device, a first message requesting capability information of the first device; receiving, from the first device, a second message including capability information of the first device; performing control signaling with the first device; and receiving data from the first device based on the control signaling, wherein the data or a message received through the control signaling, as information for a key refreshing procedure for a data sharing service based on homomorphic encryption, includes a secret key of the first device encrypted by using a first reference public key based on public keys of updated members and is used to convert data encrypted by using a second reference public key determined before the key refreshing procedure into data encrypted by using the first reference public key.

As an example of the present disclosure, provided is a first device in a wireless communication system. The first device may comprise: a transceiver; and a processor connected to the transceiver, wherein the processor is configured to: receive, from a second device, a first message requesting capability information of the first device; transmit, to the second device, a second message including capability information of the first device; perform control signaling with the second device; and control to transmit data based on the control signaling, wherein the data or a message transmitted through the control signaling, as information for a key refreshing procedure for a data sharing service based on homomorphic encryption, includes a secret key of the first device encrypted by using a first reference public key based on public keys of updated members and is used to convert data encrypted by using a second reference public key determined before the key refreshing procedure into data encrypted by using the first reference public key.

As an example of the present disclosure, provided is a second device in a wireless communication system. The second device may comprise: a transceiver; and a processor connected to the transceiver, wherein the processor is configured to: transmit, to a first device, a first message requesting capability information of the first device; receive, from the first device, a second message including the capability information of the first device; perform control signaling with the first device; and control to receive data from the first device based on the control signaling, wherein the data or a message received through the control signaling, as information for a key refreshing procedure for a data sharing service based on homomorphic encryption, includes a secret key of the first device encrypted by using a first reference public key based on public keys of updated members and is used to convert data encrypted by using a second reference public key determined before the key refreshing procedure into data encrypted by using the first reference public key.

As an example of the present disclosure, provided is a communication device. The communication device may comprise: at least one processor; at least one computer memory connected to the at least one processor and storing instructions for instructing operations based on being executed by the at least one processor, wherein the operations comprise: receiving, from another device, a first message requesting capability information of the communication device; transmitting, to the other device, a second message including capability information of the communication device; performing control signaling with the other device; and transmitting data based on the control signaling, wherein the data or a message transmitted through the control signaling, as information for a key refreshing procedure for a data sharing service based on homomorphic encryption, includes a secret key of the communication device encrypted by using a first reference public key based on public keys of updated members and is used to convert data encrypted by using a second reference public key determined before the key refreshing procedure into data encrypted by using the first reference public key.

As an example of the present disclosure, provided is a non-transitory computer-readable medium storing at least one instruction. The non-transitory computer-readable medium may comprise: the at least one instruction executable by a processor, wherein the at least one instruction controls a device to: receive, from another device, a first message requesting capability information of the device; transmit, to the other device, a second message including capability information of the device; perform control signaling with the other device; and control to transmit data based on the control signaling, wherein the data or a message transmitted through the control signaling, as information for a key refreshing procedure for a data sharing service based on homomorphic encryption, includes a secret key of the device encrypted by using a first reference public key based on public keys of updated members and is used to convert data encrypted by using a second reference public key determined before the key refreshing procedure into data encrypted by using the first reference public key.

The above-described aspects of the present disclosure are merely some of the preferred embodiments of the present disclosure, and various embodiments reflecting the technical features of the present disclosure may be derived and understood by those of ordinary skill in the art based on the following detailed description of the disclosure.

As is apparent from the above description, the embodiments of the present disclosure have the following effects.

Based on the present disclosure, encrypted data can be efficiently shared.

It will be appreciated by persons skilled in the art that that the effects that can be achieved through the embodiment(s) are not limited to those described above and other advantageous effects of the present disclosure will be more clearly understood from the following detailed description. That is, unintended effects according to implementation of the present disclosure may be derived by those skilled in the art from the embodiment(s).

### BRIEF DESCRIPTION OF THE DRAWINGS

The accompanying drawings are provided to help understanding of the present disclosure, and may provide embodiments of the present disclosure together with a detailed description. However, the technical features of the present disclosure are not limited to specific drawings, and the features disclosed in each drawing may be combined with each other to constitute a new embodiment. Reference numerals in each drawing may refer to structural elements.

FIG. 1 shows an example of a communication system applicable to the present disclosure.

FIG. 2 shows an example of a wireless device applicable to the present disclosure.

FIG. 3 shows a method of processing a transmitted signal applicable to the present disclosure.

FIG. 4 shows a communication procedure between a terminal and a base station applicable to the present disclosure.

FIG. 5 shows an example of a communication structure providable in a 6th generation (6G) system applicable to the present disclosure.

FIG. 6 shows an electromagnetic spectrum applicable to the present disclosure.

FIG. 7 shows a THz communication method applicable to the present disclosure.

FIG. 8 shows a THz wireless communication transceiver applicable to the present disclosure.

FIG. 9 shows a THz signal generation method applicable to the present disclosure.

FIG. 10 shows a wireless communication transceiver applicable to the present disclosure.

FIG. 11 shows a transmitter structure applicable to the present disclosure.

FIG. 12 shows a modulator structure applicable to the present disclosure.

FIG. 13 shows a structure of a system supporting a cloud service based on an embodiment of the present disclosure.

FIGS. 14a to 14f show examples of arrangements of entities sharing data based on various embodiments of the present disclosure.

FIG. 15 shows an example of a data sharing environment based on an embodiment of the present disclosure.

FIG. 16 shows an example of a procedure of using shared data based on an embodiment of the present disclosure.

FIG. 17 shows an example of a procedure of managing shared data based on an embodiment of the present disclosure.

FIG. 18 shows an example of a procedure of using shared data based on homomorphic encryption based on an embodiment of the present disclosure.

FIG. 19 shows an example of a procedure of managing shared data based on homomorphic encryption based on an embodiment of the present disclosure.

FIG. 20 shows an example of an initialization procedure for sharing encrypted data based on homomorphic encryption based on an embodiment of the present disclosure.

FIG. 21 shows an example of a state initialized for sharing encrypted data based on homomorphic encryption based on an embodiment of the present disclosure.

FIG. 22 shows an example of a procedure of uploading and downloading encrypted data based on homomorphic encryption based on an embodiment of the present disclosure.

FIG. 23 shows an example of data delivered for uploading and downloading encrypted data based on homomorphic encryption based on an embodiment of the present disclosure.

FIG. 24 shows an example of a procedure of key refreshing to change a key for encryption based on homomorphic encryption based on an embodiment of the present disclosure.

FIG. 25 shows an example of data delivered for key refreshing to change a key for encryption based on homomorphic encryption based on an embodiment of the present disclosure.

FIG. 26 shows an example of a procedure of removing a member from a group sharing data based on homomorphic encryption based on an embodiment of the present disclosure.

FIG. 27 shows an example of data delivered for removing a member from a group sharing data based on homomorphic encryption based on an embodiment of the present disclosure.

FIG. 28 shows an example of a procedure of adding a member to a group sharing data based on homomorphic encryption based on an embodiment of the present disclosure.

FIG. 29 shows an example of data delivered for adding a member to a group sharing data based on homomorphic encryption based on an embodiment of the present disclosure.

FIG. 30 shows an example of a procedure of dividing a group sharing data based on homomorphic encryption based on an embodiment of the present disclosure.

FIG. 31 shows an example of data delivered for dividing a group sharing data based on homomorphic encryption based on an embodiment of the present disclosure.

FIG. 32 shows an example of a procedure of merging groups sharing data based on homomorphic encryption based on an embodiment of the present disclosure.

FIG. 33 shows an example of data delivered for merging groups sharing data based on homomorphic encryption based on an embodiment of the present disclosure.

### DETAILED DESCRIPTION

The embodiments of the present disclosure described below are combinations of elements and features of the present disclosure in specific forms. The elements or features may be considered selective unless otherwise mentioned. Each element or feature may be practiced without being combined with other elements or features. Further, the embodiment(s) may be constructed by combining parts of the elements and/or features. Operation orders described in the embodiment(s) may be rearranged. Some constructions or elements of any one embodiment may be included in another embodiment and may be replaced with corresponding constructions or features of another embodiment.

In the description of the drawings, procedures or steps which render the scope of the present disclosure unnecessarily ambiguous will be omitted and procedures or steps which can be understood by those skilled in the art will be omitted.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an”, “one”, “the” etc. may include a singular representation and a plural representation in the context of the present disclosure (more particularly, in the context of the following claims) unless indicated otherwise in the specification or unless context clearly indicates otherwise.

In the embodiment(s), a description is mainly made of a data transmission and reception relationship between a base station (BS) and a mobile station. A BS refers to a terminal node of a network, which directly communicates with a mobile station. A specific operation described as being performed by the BS may be performed by an upper node of the BS.

Namely, it is apparent that, in a network comprised of a plurality of network nodes including a BS, various operations performed for communication with a mobile station may be performed by the BS, or network nodes other than the BS. In this case, the term “BS” may be replaced with a fixed station, a Node B, an eNB (eNode B), a gNB (gNode B), an ng-eNB, an advanced base station (ABS), an access point, etc.

In addition, in the embodiment(s) of the present disclosure, the term terminal may be replaced with a user equipment (UE), a mobile station (MS), a subscriber station (SS), a mobile subscriber station (MSS), a mobile terminal, an advanced mobile station (AMS), etc.

In addition, a transmitter is a fixed and/or mobile node that provides a data service or a call service and a receiver is a fixed and/or mobile node that receives a data service or a call service. Therefore, a mobile station may serve as a transmitter and a BS may serve as a receiver, on an uplink (UL). Likewise, the mobile station may serve as a receiver and the BS may serve as a transmitter, on a downlink (DL).

The embodiment(s) may be supported by standard specifications disclosed for at least one of wireless access systems including an Institute of Electrical and Electronics Engineers (IEEE) 802.xx system, a 3rd Generation Partnership Project (3GPP) system, a 3GPP Long Term Evolution (LTE) system, 3GPP 5th generation (5G) new radio (NR) system, and a 3GPP2 system. In particular, the embodiment(s) may be supported by the standard specifications, 3GPP TS 38.211, 3GPP TS 38.212, 3GPP TS 38.213, 3GPP TS 38.321 and 3GPP TS 38.331.

In addition, the embodiment(s) are applicable to other radio access systems and are not limited to the above-described system. For example, the embodiments of the present disclosure are applicable to systems applied after a 3GPP 5G NR system and are not limited to a specific system.

That is, steps or parts that are not described to clarify the technical features of the present disclosure may be supported by those documents. Further, all terms as set forth herein may be explained by the standard documents.

Reference will now be made in detail to the embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the disclosure.

The following detailed description includes specific terms in order to provide a thorough understanding of the present disclosure. However, it will be apparent to those skilled in the art that the specific terms may be replaced with other terms without departing the technical spirit and scope of the present disclosure.

The embodiments of the present disclosure can be applied to various radio access systems such as code division multiple access (CDMA), frequency division multiple access (FDMA), time division multiple access (TDMA), orthogonal frequency division multiple access (OFDMA), single carrier frequency division multiple access (SC-FDMA), etc.

Hereinafter, in order to clarify the following description, a description is made based on a 3GPP communication system (e.g., LTE, NR, etc.), but the technical spirit of the present disclosure is not limited thereto. LTE may refer to technology after 3GPP TS 36.xxx Release 8. In detail, LTE technology after 3GPP TS 36.xxx Release 10 may be referred to as LTE-A, and LTE technology after 3GPP TS 36.xxx Release 13 may be referred to as LTE-A pro. 3GPP NR may refer to technology after TS 38.xxx Release 15. 3GPP 6G may refer to technology after TS Release 17 and/or Release 18. “xxx” may refer to a detailed number of a standard document. LTE/NR/6G may be collectively referred to as a 3GPP system.

For background arts, terms, abbreviations, etc. used in the present disclosure, refer to matters described in the standard documents published prior to the present disclosure. For example, reference may be made to the standard documents 36.xxx and 38.XXX.

### Communication System Applicable to the Present Disclosure

Without being limited thereto, various descriptions, functions, procedures, proposals, methods and/or operational flowcharts of the present disclosure disclosed herein are applicable to various fields requiring wireless communication/connection (e.g., 5G).

Hereinafter, a more detailed description will be given with reference to the drawings. In the following drawings/description, the same reference numerals may exemplify the same or corresponding hardware blocks, software blocks or functional blocks unless indicated otherwise.

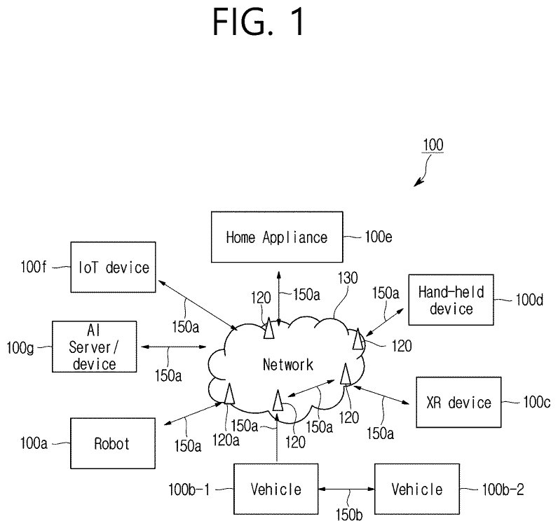

FIG. 1 shows an example of a communication system applicable to the present disclosure.

Referring to FIG. 1, the communication system 100 applicable to the present disclosure includes a wireless device, a base station and a network. The wireless device refers to a device for performing communication using radio access technology (e.g., LTE, LTE-A, LTE-A pro, NR or 5G, 5G-A, 6G) and may be referred to as a communication/wireless/5G device. Without being limited thereto, the wireless device may include a robot 100a, vehicles 100b-1 and 100b-2, an extended reality (XR) device 100c, a hand-held device 100d, a home appliance 100e, an Internet of Thing (IoT) device 100f, and an artificial intelligence (AI) device/server 100g. For example, the vehicles may include a vehicle having a wireless communication function, an autonomous vehicle, a vehicle capable of performing vehicle-to-vehicle communication, etc. The vehicles 100b-1 and 100b-2 may include an unmanned aerial vehicle (UAV) (e.g., a drone). The XR device 100c includes an augmented reality (AR)/virtual reality (VR)/mixed reality (MR) device and may be implemented in the form of a head-mounted device (HMD), a head-up display (HUD) provided in a vehicle, a television, a smartphone, a computer, a wearable device, a home appliance, a digital signage, a vehicle or a robot. The hand-held device 100d may include a smartphone, a smart pad, a wearable device (e.g., a smart watch or smart glasses), a computer (e.g., a laptop), etc. The home appliance 100e may include a TV, a refrigerator, a washing machine, etc. The IoT device 100f may include a sensor, a smart meter, etc. For example, the base station 140 and the network 130 may be implemented by a wireless device, and a specific wireless device 140a may operate as a base station/network node for another wireless device.

The wireless devices 100a to 100f may be connected to the network 130 through the base station 140. AI technology is applicable to the wireless devices 100a to 100f, and the wireless devices 100a to 100f may be connected to the AI server 100g through the network 130. The network 130 may be configured using a 3G network, a 4G (e.g., LTE) network, a 5G (e.g., NR) network or a 6G network, etc. The wireless devices 100a to 100f may communicate with each other through the base station 140/the network 130 or perform direct communication (e.g., sidelink communication) without through the base station 140/the network 130. For example, the vehicles 100b-1 and 100b-2 may perform direct communication (e.g., vehicle to vehicle (V2V)/vehicle to everything (V2X) communication). In addition, the IoT device 100f (e.g., a sensor) may perform direct communication with another IoT device (e.g., a sensor) or the other wireless devices 100a to 100f.

Wireless communications/connections 150a, 150b, 150c may be established between the wireless devices 100a to 100f/the base station 140 and the base station 140/the base station 140. Here, wireless communication/connection may be established through various radio access technologies such as uplink/downlink communication 150a, sidelink communication 150b (or D2D communication) or communication 150c between base stations (e.g., relay, integrated access backhaul (IAB). The wireless device and the base station/wireless device, the base station and the base station may transmit/receive radio signals to/from each other through wireless communication/connection 150a, 150b, 150c. For example, wireless communication/connection 150a, 150b, 150c may enable signal transmission/reception through various physical channels. To this end, based on the various proposals of the present disclosure, at least some of various configuration information setting processes for transmission/reception of radio signals, various signal processing procedures (e.g., channel encoding/decoding, modulation/demodulation, resource mapping/demapping, etc.), resource allocation processes, etc. may be performed.

### Device Applicable to the Present Disclosure

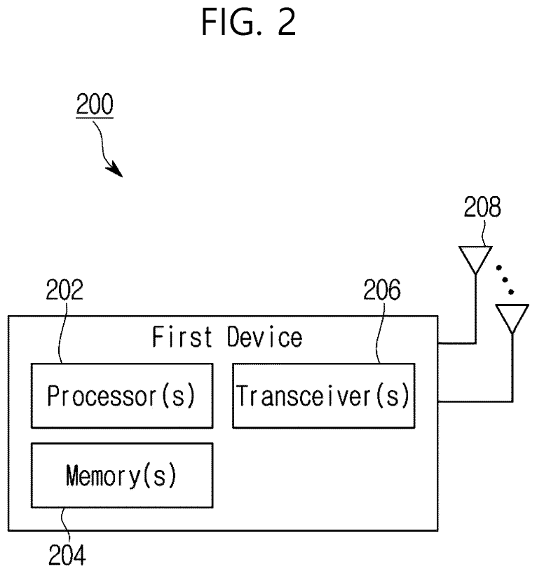

FIG. 2 shows an example of a wireless device applicable to the present disclosure.

Referring to FIG. 2, a wireless device 200 may transmit and receive radio signals through various radio access technologies (e.g., LTE, LTE-A, LTE-A pro, NR, 5G, 5G-A, 6G). The wireless device 200 includes at least one processor 202 and at least one memory 204, and may further include at least one transceiver 206 and/or at least one antenna 208.

The processor 202 may be configured to control the memory 204 and/or the transceiver 206 and to implement descriptions, functions, procedures, proposals, methods and/or operational flowcharts disclosed herein. For example, the processor 202 may process information in the memory 204 to generate first information/signal and then transmit a radio signal including the first information/signal through the transceiver 206. In addition, the processor 202 may receive a radio signal including second information/signal through the transceiver 206 and then store information obtained from signal processing of the second information/signal in the memory 204. The memory 204 may be coupled with the processor 202, and store a variety of information related to operation of the processor 202. For example, the memory 204 may store software code including instructions for performing all or some of the processes controlled by the processor 202 or performing the descriptions, functions, procedures, proposals, methods and/or operational flowcharts disclosed herein. Here, the processor 202 and the memory 204 may be part of a communication modem/circuit/chip designed to implement wireless communication technology. The transceiver 206 may be coupled with the processor 202 to transmit and/or receive radio signals through at least one antenna 208. The transceiver 206 may include a transmitter and/or a receiver. The transceiver 206 may be used interchangeably with a radio frequency (RF) unit. In the present disclosure, the wireless device may refer to a communication modem/circuit/chip.

Hereinafter, hardware elements of the wireless device 200 will be described in greater detail. Without being limited thereto, at least one protocol layer may be implemented by at least one processor 202. For example, at least one processor 202 may implement at least one layer (e.g., functional layers such as physical (PHY), media access control (MAC), radio link control (RLC), packet data convergence protocol (PDCP), radio resource control (RRC), service data adaptation protocol (SDAP)). At least one processor 202 may generate at least one protocol data unit (PDU) and/or at least one service data unit (SDU) according to the descriptions, functions, procedures, proposals, methods and/or operational flowcharts disclosed herein. At least one processor 202 may generate messages, control information, data or information according to the descriptions, functions, procedures, proposals, methods and/or operational flowcharts disclosed herein. At least one processor 202 may generate PDUs, SDUs, messages, control information, data or information according to the functions, procedures, proposals and/or methods disclosed herein and provide the PDUs, SDUs, messages, control information, data or information to at least one transceiver 206. At least One processor 202 may receive signals (e.g., baseband signals) from at least one transceiver 206 and acquire PDUs, SDUs, messages, control information, data or information according to the descriptions, functions, procedures, proposals, methods and/or operational flowcharts disclosed herein.

At least one processor 202 may be referred to as controllers, microcontrollers, microprocessors or microcomputers. At least one processor 202 may be implemented by hardware, firmware, software or a combination thereof. For example, at least one application specific integrated circuit (ASIC), at least one digital signal processor (DSP), at least one digital signal processing device (DSPD), at least one programmable logic device (PLD) or at least one field programmable gate array (FPGAs) may be included in at least one processor 202. The descriptions, functions, procedures, proposals, methods and/or operational flowcharts disclosed herein may be implemented using firmware or software, and firmware or software may be implemented to include modules, procedures, functions, etc. Firmware or software configured to perform the descriptions, functions, procedures, proposals, methods and/or operational flowcharts disclosed herein may be included in at least one processor 202 or stored in at least one memory 204 to be driven by at least one processor 202. The descriptions, functions, procedures, proposals, methods and/or operational flowcharts disclosed herein implemented using firmware or software in the form of code, a command and/or a set of commands.

At least one memory 204 may be coupled with at least one processor 202 to store various types of data, signals, messages, information, programs, code, instructions and/or commands. At least one memory 204 may be composed of read only memories (ROMs), random access memories (RAMs), erasable programmable read only memories (EPROMs), flash memories, hard drives, registers, cache memories, computer-readable storage mediums and/or combinations thereof. At least one memory 204 may be located inside and/or outside at least one processor 202. In addition, at least one memory 204 may be coupled with at least one processor 202 through various technologies such as wired or wireless connection.

At least one transceiver 206 may transmit user data, control information, radio signals/channels, etc. described in the methods and/or operational flowcharts of the present disclosure to at least one other device. At least one transceiver 206 may receive user data, control information, radio signals/channels, etc. described in the methods and/or operational flowcharts of the present disclosure from at least one other device. For example, at least one transceiver 206 may be coupled with at least one processor 202 to transmit/receive radio signals. For example, at least one processor 202 may perform control such that at least one transceiver 206 transmit user data, control information or radio signals to at least one other device. In addition, at least one processor 202 may perform control such that at least one transceiver 206 receive user data, control information or radio signals from at least one other device. In addition, at least one transceiver 206 may be coupled with at least one antenna 208, and at least one transceiver 206 may be configured to transmit/receive user data, control information, radio signals/channels, etc. described in the descriptions, functions, procedures, proposals, methods and/or operational flowcharts disclosed herein through at least one antenna 208. In the present disclosure, at least one antenna may be a plurality of physical antennas or a plurality of logical antennas (e.g., antenna ports). At least one transceiver 206 may convert the received radio signals/channels, etc. from RF band signals to baseband signals, in order to process the received user data, control information, radio signals/channels, etc. using at least one processor 202. At least one transceiver 206 may convert the user data, control information, radio signals/channels processed using at least one processor 202 from baseband signals into RF band signals. To this end, at least one transceiver 206 may include (analog) oscillator and/or filters.

Referring to FIG. 2, components of a wireless device described may be referred to by different terms in terms of functionality. For example, the processor 202 may be referred to as a controller, the transceiver 206 may be referred to as a communication unit, and the memory 204 may be referred to as a storage unit. In some cases, the communication unit may be used to mean including at least a part of the processor 202 and the transceiver 206.

Referring to FIG. 2, a structure of a wireless device described may be understood as at least a part of the structure of various devices. For example, the structure of the wireless device shown in FIG. 2 may be at least a part of the various devices described with reference to FIG. 1 (e.g., a robot 100a, vehicles 100b-1, 100b-2, an XR device 100c, a hand-held device 100d, a home appliance 100e, an IoT device 100f, an AI device/server 100g). Furthermore, based on various embodiments, in addition to the components shown in FIG. 2, the device may further include other components.

For example, the device may be a hand-held device such as a smartphone, a smart pad, a wearable device (e.g., a smart watch, smart glasses), or a hand-held computer (e.g., a laptop, etc.). In this case, the device may further include at least one of an input/output unit for inputting and outputting video information/signals, audio information/signals, data, and/or information input by a user, a power supply unit that supplies power and includes a wired/wireless charging circuit, a battery, etc., an interface unit including at least one port (e.g., an audio input/output port, a video input/output port) for connection with another device.

For example, the device may be a mobile device such as a mobile robot, a vehicle, a train, a manned/unmanned aerial vehicle (AV), a ship, etc. In this case, the device may further include at least one of a position measurement unit that acquires location information of the mobile device through a GPS (global positioning system), various sensors, a driving unit including at least one of an engine, a motor, a power train, wheels, brakes, a steering device of the device, a power supply unit that supplies power and includes a wired/wireless charging circuit, a battery, etc., a sensor unit that senses state information, environmental information, user information of or around the device, an autonomous driving unit that performs functions such as path maintenance, velocity control, destination setting, etc.

For example, the device may be an XR device such as an HMD, a head-up display (HUD) provided in a vehicle, a television, a smartphone, a computer, a wearable device, a home appliance, a digital signage, a vehicle, a robot, etc. In this case, the device may further include at least one of a sensor unit that senses state information, environmental information, user information of or around the device, a power supply unit that supplies power and includes a wired/wireless charging circuit, a battery, etc., an input/output unit that acquires control information, data, etc., from outside and outputs generated XR objects.

For example, the device may be a robot that may be classified into industrial, medical, household, military, etc., use depending on the purpose or field of use. In this case, the device may further include at least one of a driving unit that performs various physical operations such as moving robot joints, a sensor unit that senses state information, environmental information, user information of or around the device.

For example, the device may be an AI device such as a TV, a projector, a smartphone, a PC, a laptop, a digital broadcast terminal, a tablet PC, a wearable device, a set-top box (STB), a radio, a washing machine, a refrigerator, a digital signage, a robot, or a vehicle, or the like. In this case, the device may further include at least one of a training unit that trains a model configured with an artificial neural network by using training data, an input unit that acquires various types of data from outside, an output unit that generates outputs related to vision, hearing, touch, and the like, a sensor unit that senses state information, environmental information, or user information of or around the device.

The structure of the wireless device shown in FIG. 2 may be understood as a part of a RAN node (e.g., a base station, a DU, an RU, an RRU, etc.). That is, the device shown in FIG. 2 may be a RAN node. In this case, the device may further include a wired transceiver for front haul and/or back haul communication. However, if the front haul and/or back haul communication is based on wireless communication, at least one transceiver 206 shown in FIG. 2 may be used for the front haul and/or back haul communication, and a wired transceiver may not be included.

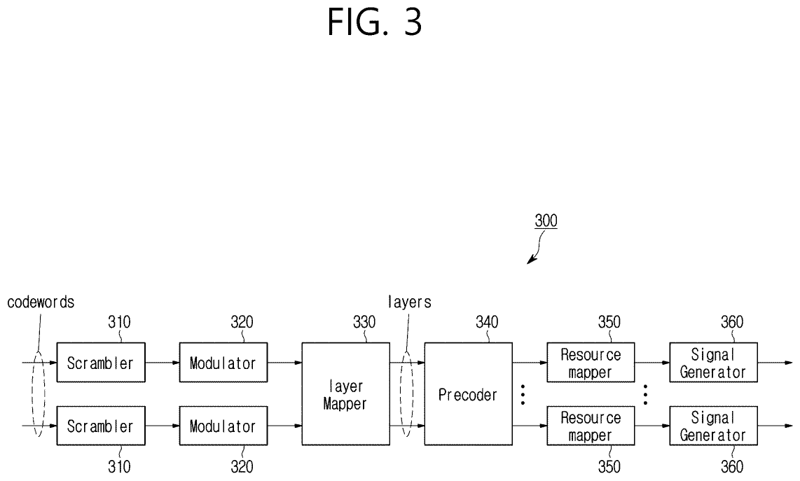

FIG. 3 shows a method of processing a transmitted signal applicable to the present disclosure. For example, the transmitted signal may be processed by a signal processing circuit. At this time, a signal processing circuit 300 may include a scrambler 310, a modulator 320, a layer mapper 330, a precoder 340, a resource mapper 350, a signal generator 360. At this time, for example, the operations/functions of FIG. 3 may be performed by the processor 202 and/or the transceiver 206 of FIG. 2. In addition, for example, the hardware element of FIG. 3 may be implemented in the processor 202 and/or the transceiver 206 of FIG. 2. For example, blocks 310 to 360 may be implemented in the processor 202 of FIG. 2. In addition, blocks 310 to 350 may be implemented in the processor 202 of FIG. 2, and block 360 may be implemented in the transceiver 206 of FIG. 2, without being limited to the above-described embodiments.

A codeword may be converted into a radio signal through the signal processing circuit 300 of FIG. 3. Here, the codeword is a coded bit sequence of an information block. The information block may include a transport block (e.g., a UL-SCH transport block, a DL-SCH transport block). The radio signal may be transmitted through various physical channels (e.g., a PUSCH, a PDSCH). Specifically, the codeword may be converted into a bit sequence scrambled by the scrambler 310. The scramble sequence used for scramble is generated based in an initial value and the initial value may include ID information of a wireless device, etc. The scrambled bit sequence may be modulated into a modulated symbol sequence by the modulator 320. The modulation method may include pi/2-binary phase shift keying (pi/2-BPSK), m-phase shift keying (m-PSK), m-quadrature amplitude modulation (m-QAM), etc.

A complex modulation symbol sequence may be mapped to at least one transport layer by the layer mapper 330. Modulation symbols of each transport layer may be mapped to corresponding antenna port(s) by the precoder 340. The output z of the precoder 340 may be obtained by multiplying the output y of the layer mapper 330 by a precoding matrix W of NXM. Here, N may be the number of antenna ports and M may be the number of transport layers. Here, the precoder 340 may perform precoding after transform precoding (e.g., discrete Fourier transform (DFT)) for complex modulation symbols. In addition, the precoder 340 may perform precoding without performing transform precoding.

The resource mapper 350 may map modulation symbols of each antenna port to time-frequency resources. The time-frequency resources may include a plurality of symbols (e.g., a CP-OFDMA symbol, a DFT-s-OFDMA symbol) in the time domain and include a plurality of subcarriers in the frequency domain. The signal generator 360 may generate a radio signal from the mapped modulation symbols, and the generated radio signal may be transmitted to another device through each antenna. To this end, the signal generator 360 may include an inverse fast Fourier transform (IFFT) module and a cyclic prefix (CP) insertor, a digital-to-analog converter (DAC), a frequency uplink converter, etc.

A signal processing procedure for a received signal in the wireless device may be configured as the inverse of the signal processing procedures 310 to 360 of FIG. 3. For example, the wireless device (e.g., 200 of FIG. 2) may receive a radio signal from the outside through an antenna port/transceiver. The received radio signal may be converted into a baseband signal through a signal restorer. To this end, the signal restorer may include a frequency downlink converter, an analog-to-digital converter (ADC), a CP remover, a fast Fourier transform (FFT) module. Thereafter, the baseband signal may be restored to a codeword through a resource de-mapper process, a postcoding process, a demodulation process and a de-scrambling process. The codeword may be restored to an original information block through decoding. Accordingly, a signal processing circuit (not shown) for a received signal may include a signal restorer, a resource de-mapper, a postcoder, a demodulator, a de-scrambler and a decoder.

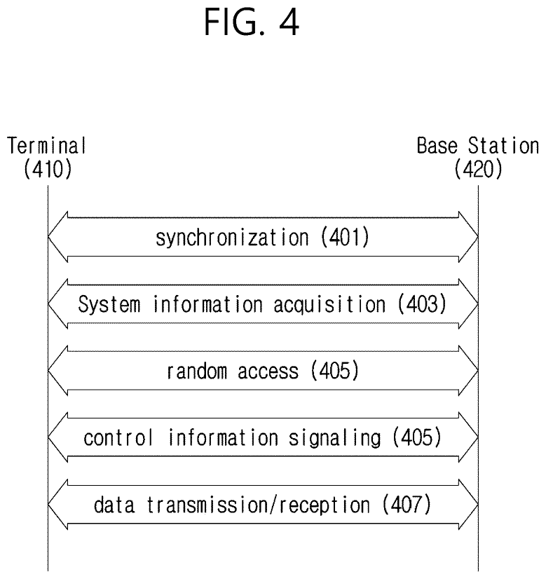

FIG. 4 shows a communication procedure between a terminal and a base station applicable to the present disclosure. FIG. 4 shows operations in which a terminal 410 and a base station 420 transmit and/or receive data, and operations performed prior thereto.

Referring to FIG. 4, in step 401, a terminal 410 and a base station 420 perform synchronization. For example, the terminal 410 performs an initial cell search operation. Specifically, the terminal 410 may detect at least one synchronization signal transmitted from the base station 420 based on a predefined rule. Here, the synchronization signal may include a plurality of synchronization signals classified based on structure or usage (e.g., a primary synchronization signal, a secondary synchronization signal). Through this, the terminal 410 may identify boundaries of a frame, a subframe, a slot, and/or a symbol of the base station 420, and may acquire information about the base station 420 (e.g., a cell identifier).

In step 403, the terminal 410 acquires system information transmitted from the base station 420. The system information is information related to attributes, characteristics, and/or capabilities of the base station 420 necessary to access the base station 420 and use a service, and may be classified based on content (e.g., whether it is essential for access), transmission structure (e.g., which channel is used, whether it is provided on-demand). For example, the system information may be classified into a master information block (MIB) and a system information block (SIB). If necessary, the terminal 410 may transmit a signal requesting the system information before receiving the system information. However, the requesting and providing of the system information may be performed after random access procedure described later.

In step 405, the terminal 410 and the base station 420 perform random access procedure. The terminal 410 may transmit and/or receive at least one message (e.g., random access preamble, random access response (RAR) message, etc.) for random access procedure based on information related to random access channel of the base station 420 (e.g., channel location, channel structure, structure of supported preambles, etc.) acquired through system information. For example, the terminal 410 may transmit a preamble (e.g., MSG1) through random access channel, receive an RAR message (e.g., MSG2), transmit to the base station 420 a message (e.g., MSG3) including information related to the terminal 410 (e.g., identification information) by using scheduling information included in the RAR message, and receive a message (e.g., MSG4) for contention resolution and/or connection establishment. In another example, MSG1 and MSG3 may be transmitted and received as a single message, or MSG2 and MSG4 may be transmitted and received as a single message.

In step 407, the terminal 410 and the base station 420 perform signaling of control information. Here, the control information may be defined in various layers such as a layer controlling connections (e.g., a radio resource control (RRC) layer), a layer handling mapping between logical channels and transport channels (e.g., a media access control (MAC) layer), a layer that handles physical channels (e.g., a physical (PHY) layer). For example, the terminal 410 and the base station 420 may perform at least one of signaling for establishing a connection, signaling for determining settings related to communication, signaling for indicating allocated resources.

In step 409, the terminal 410 and the base station 420 transmit and/or receive data. In other words, the terminal 410 and the base station 420 process and transmit and/or receive data based on signaling of control information. For example, when transmitting data, the terminal 410 or the base station 420 may perform at least one of channel encoding, rate matching, scrambling, constellation mapping, layer mapping, waveform modulation, antenna mapping, resource mapping on information bits. Conversely, when receiving data, the terminal 410 or the base station 420 may perform at least one of signal extraction from resources, waveform demodulation per antenna, signal placement considering layer mapping, constellation demapping, descrambling, channel decoding.

### 6G Communication System and Core Enabling Technologies of the 6G System

A 5G system defines various operating bands within frequency range 1 (FR1) including 410 MHz to 7125 MHz and frequency range 2 (FR2) including 24,250 MHz to 71,000 MHz. For subsequent 6G system operating bands, various frequencies are being discussed, and the use of higher frequencies than those of the 5G system is being considered for wider bandwidth and higher transmission rates. As one example, the use of the Terahertz (THz) frequency band including approximately 100 GHz to 10 THz is being discussed. The THz frequency band has both the permeability of radio waves and the straightness of light waves, and communication using the THz frequency band is also expected to serve as a transitional role from communication centered on radio waves to communication based on light waves.

In this way, a 6G system utilizing the THz frequency has purposes such as i) very high data rate per device, ii) a very large number of connected devices, iii) global connectivity, iv) very low latency, v) decrease in energy consumption of battery-free IoT devices, vi) ultra-reliable connectivity, vii) connected intelligence with machine learning capacity, etc. The vision of the 6G system may include four aspects such as “intelligent connectivity”, “deep connectivity”, “holographic connectivity”, “ubiquitous connectivity”, and the 6G system may be designed to satisfy the requirements shown in [Table 1] below.

TABLE 1

| | | |
|---|---|---|
| Per device peak data rate | 1 | Tbps |
| E2E latency | 1 | ms |
| Maximum spectral efficiency | 100 | bps/Hz |

| | |
|---|---|
| Mobility support | Up to 1000 km/hr |
| Satellite integration | Fully |
| AI | Fully |
| Autonomous vehicle | Fully |
| XR | Fully |
| Haptic Communication | Fully |

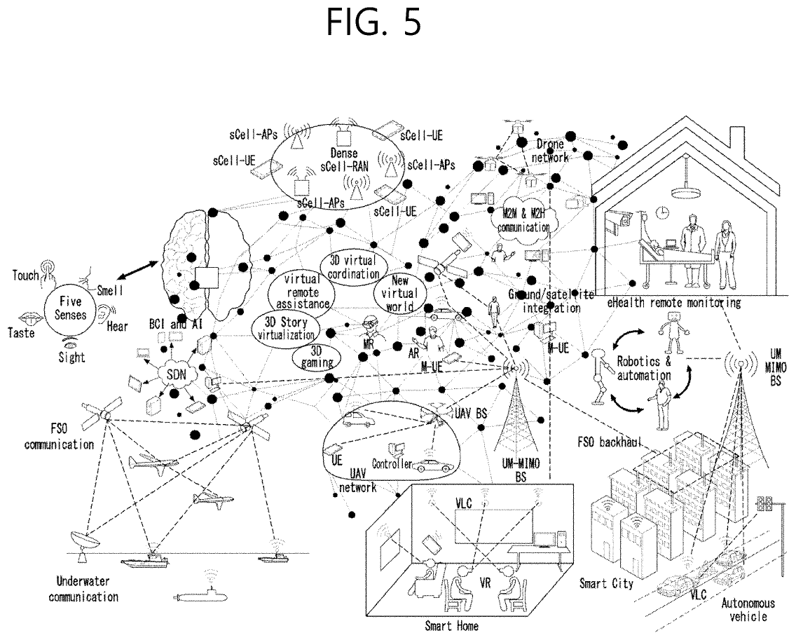

At this time, the 6G system may have key factors such as enhanced mobile broadband (eMBB), ultra-reliable low latency communications (URLLC), massive machine type communications (mMTC), AI integrated communication, tactile Internet, high throughput, high network capacity, high energy efficiency, low backhaul and access network congestion and enhanced data security. FIG. 5 shows an example of a communication structure providable in a 6G system applicable to the present disclosure. Referring to FIG. 5, the 6G system will have 50 times higher simultaneous wireless communication connectivity than a 5G wireless communication system. URLLC, which is the key feature of 5G, will become more important technology by providing end-to-end latency less than 1 ms in 6G communication. At this time, the 6G system may have much better volumetric spectrum efficiency unlike frequently used domain spectrum efficiency. The 6G system may provide advanced battery technology for energy harvesting and very long battery life and thus mobile devices may not need to be separately charged in the 6G system.

As core enabling technologies of the 6G system, technologies such as artificial intelligence (AI), Terahertz (THz) communication, optical wireless technology, FSO backhaul networks, large-scale MIMO technology, blockchain, 3D networking, quantum communication, unmanned aerial vehicles, cell-free communication, wireless information and energy transfer (WIET), integration of sensing and communication, integration of access and backhaul networks, holographic beamforming, big data analytics, large intelligent surfaces (LIS), etc. may be adopted.

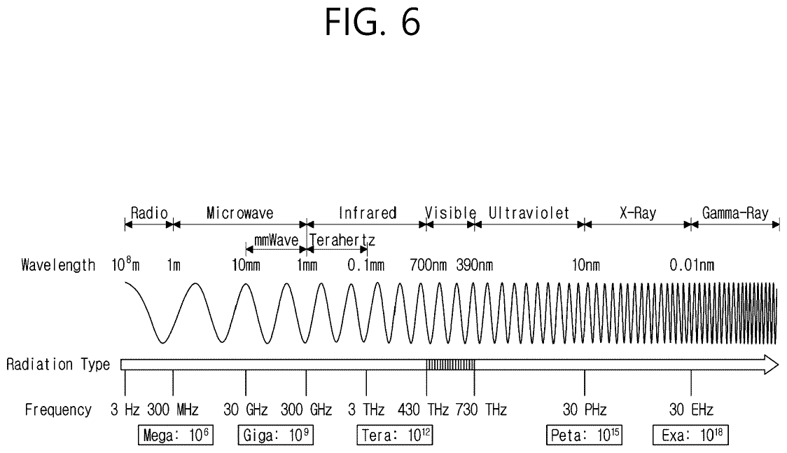

THz communication uses a spectrum in a frequency band between 0.1 THz and 10 THz having a corresponding wavelength range of 0.03 mm to 3 mm as shown in FIG. 6. THz communication may be implemented as follows.

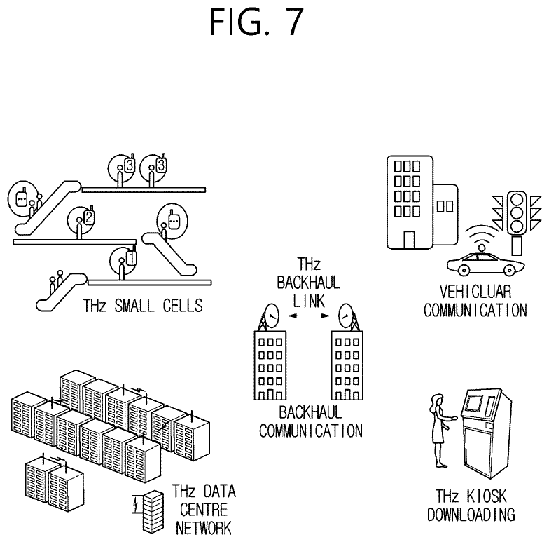

FIG. 7 shows a THz communication method applicable to the present disclosure. Referring to FIG. 7, THz wireless communication uses a THz wave having a frequency of approximately 0.1 to 10 THz (1 THz=1012 Hz), and may mean terahertz (THz) band wireless communication using a very high carrier frequency of 100 GHz or more. The THz wave is located between radio frequency (RF)/millimeter (mm) and infrared bands, and (i) transmits non-metallic/non-polarizable materials better than visible/infrared rays and has a shorter wavelength than the RF/millimeter wave and thus high straightness and is capable of beam convergence.

In addition, since the photon energy of THz waves is only a few meV, they have a property of being harmless to the human body. A frequency band expected to be used for THz wireless communication may be a D-band (110 GHz to 170 GHz) or an H-band (220 GHz to 325 GHz) band, which has low propagation loss due to molecular absorption in the air. Standardization of THz wireless communication is being discussed not only in 3GPP but also mainly in the IEEE 802.15 THz working group (WG), and standard documents published by task groups (TG) (e.g., TG3d, TG3e) of IEEE 802.15 may specify or supplement the contents described in the present specification. THz wireless communication may be applied to wireless cognition, sensing, imaging, wireless communication, THz navigation, etc.

Specifically, referring to FIG. 7, THz wireless communication scenarios may be classified into a macro network, a micro network, a nanoscale network. In a macro network, THz wireless communication may be applied to vehicle-to-vehicle (V2V) connections and backhaul/fronthaul connections. In a micro network, THz wireless communication may be applied to indoor small cell, fixed point-to-point or multi-point connection such as wireless connections in data centers, near-field communication such as kiosk downloading. Table 2 below is a table showing an example of a technology that may be used in THz waves.

TABLE 2

| | |
|---|---|
| Transceivers | Available immature: UTC-PD, RTD and SBD |
| Device | |
| Modulation | Low order modulation techniques (OOK, |
| and coding | QPSK), LDPC, Reed Soloman, Hamming, |
| | Polar, Turbo |
| Antenna | Omni and Directional, phased array with |
| | low number of antenna elements |
| Bandwidth | 69 GHz (or 23 GHz) at 300 GHz |
| Channel models | Partially |
| Data rate | 100 Gbps |
| Outdoor deployment | No |
| Fee space loss | High |
| Coverage | Low |
| Radio Measurements | 300 GHz inddor |
| Device size | Few micrometers |

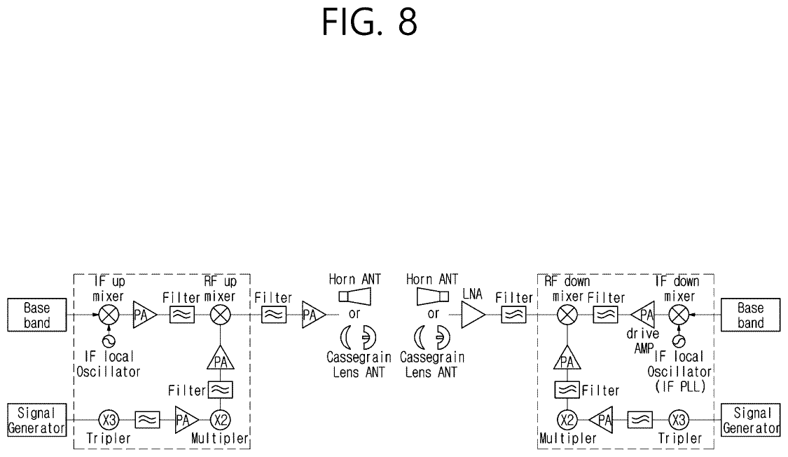

FIG. 8 shows a THz wireless communication transceiver applicable to the present disclosure. Referring to FIG. 8, THz wireless communication may be classified based on methods for THz generation and reception. A THz generation method may be classified into optical device-based technology or electronic device-based technology. In this case, a method of generating THz using an electronic device may include a method using a semiconductor device such as a resonant tunneling diode (RTD), a method using a local oscillator and a frequency multiplier, a monolithic microwave integrated circuit (MMIC) method using an integrated circuit based on a compound semiconductor high electron mobility transistor (HEMT), a method using an integrated circuit based on a Si-CMOS. In the case of FIG. 8, in order to increase frequency, a multiplier (doubler, tripler, multiplier) is applied, and after passing through a sub-harmonic mixer, the signal is radiated by an antenna. Since the THz band forms very high frequencies, a multiplier is essential. Here, a multiplier is a circuit that produces an output frequency that is N times an input frequency, matches to a desired harmonic frequency, and filters out all other frequencies. In addition, in the antenna of FIG. 8, an array antenna and the like may be applied so that beamforming may be implemented. In FIG. 8, IF denotes an intermediate frequency, a tripler and a multiplier denote a frequency multiplier, PA denotes a power amplifier, LNA denotes a low noise amplifier, and PLL denotes a phase-locked loop.

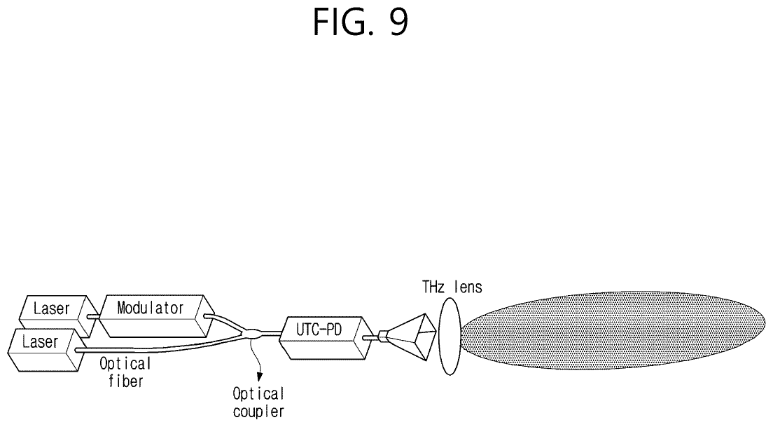

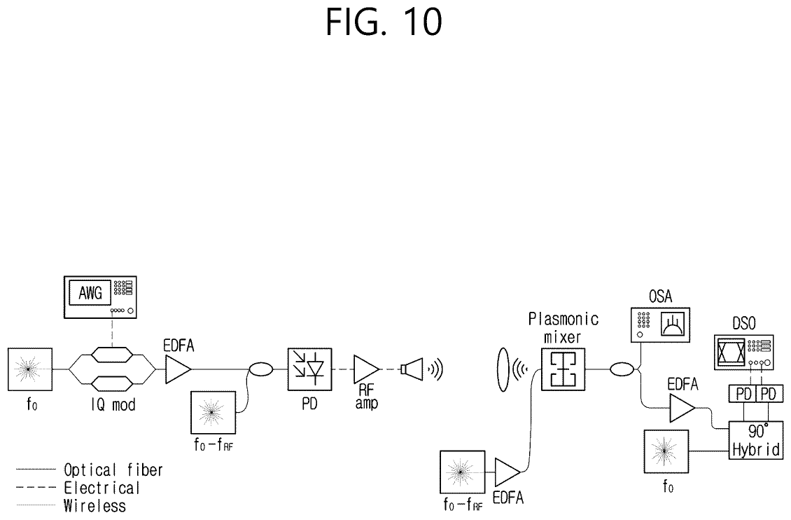

FIG. 9 shows a THz signal generation method applicable to the present disclosure. In addition, FIG. 10 shows a wireless communication transceiver applicable to the present disclosure. Referring to FIGS. 9 and 10, THz wireless communication technology based on an optical device refers to a method of generating and modulating a THz signal using an optical device. THz signal generation technology based on the optical device generates an ultra-high-speed optical signal using a laser and an optical modulator and converts the signal into a THz signal using an ultra-high-speed photodetector. Compared to a technology using only electronic devices, this technology facilitates frequency increase, enables the generation of high-power signals, and may obtain a flat response characteristic over a wide frequency band. For optical device-based THz signal generation, as shown in FIG. 9, a laser diode, a broadband optical modulator, an ultra-high-speed photodetector are required. In the case of FIG. 9, light signals of two lasers having different wavelengths are combined to generate a THz signal corresponding to a wavelength difference between the lasers. In FIG. 9, an optical coupler refers to a semiconductor device that uses light waves to transmit an electrical signal in order to provide coupling of electrical isolation between circuits or systems, and an uni-traveling carrier photo-detector (UTC-PD) is a photodetector that uses electrons as active carriers and reduces electron transit time through bandgap grading. The UTC-PD may perform photodetection at 150 GHz or higher. In FIG. 0, an erbium-doped fiber amplifier (EDFA) denotes an optical fiber amplifier doped with erbium, a photo detector (PD) denotes a semiconductor device capable of converting an optical signal into an electrical signal, an optical sub-assembly (OSA) denotes an optical module that modularizes various optical communication functions (e.g., opto-electronic conversion, electro-optic conversion, etc.) into a single component, and a DSO denotes a digital storage oscilloscope.

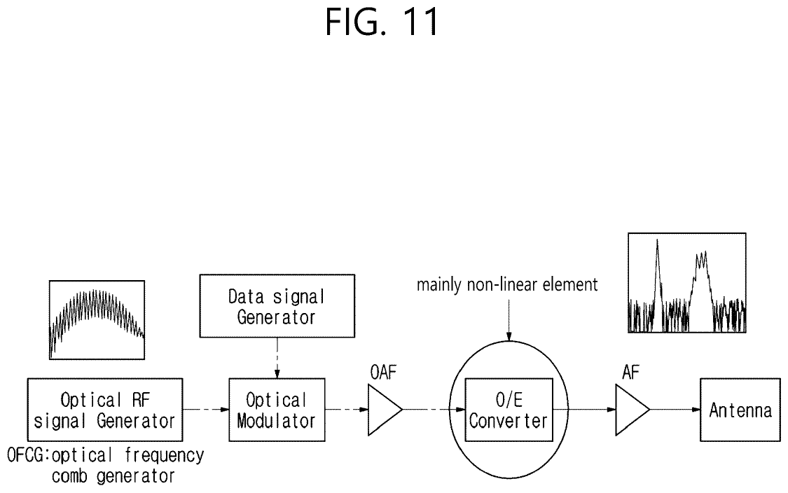

FIG. 11 shows a transmitter structure applicable to the present disclosure. In addition, FIG. 12 shows a modulator structure applicable to the present disclosure. Referring to FIGS. 11 and 12, in general, an optical source of a laser may pass through an optical wave guide so that a phase or the like of a signal may be changed. At this time, data is carried by changing electrical characteristics through a microwave contact or the like. Accordingly, an optical modulator output is formed as a modulated waveform. An O/E converter may generate a THz pulse based on optical rectification operation by a nonlinear crystal, O/E conversion by a photoconductive antenna, emission from a bunch of relativistic electrons, etc. A terahertz (THz) pulse generated in such a manner may have a length in units ranging from femtoseconds to picoseconds. The O/E converter performs down conversion by using non-linearity of a device.

Considering THz spectrum usage, for a terahertz system, it is highly likely that several contiguous GHz bands will be used for fixed or mobile services. According to outdoor scenario criteria, in a spectrum up to 1 THz, available bandwidth may be classified based on oxygen attenuation of 10\hat{ }2 dB/km. Accordingly, a framework in which the available bandwidth is composed of several band chunks may be considered. As one example of the framework, if the length of a THz pulse for one carrier is set to 50 ps, the bandwidth (BW) becomes about 20 GHz.

Effective down conversion from the infrared band to the THz band depends on how the nonlinearity of an O/E converter is utilized. That is, in order to perform down conversion to a desired THz band, it is required to design an O/E converter having non-linearity most suitable for shifting to the corresponding THz band. If an O/E converter not suitable for the target frequency band is used, errors are highly likely to occur with respect to amplitude, phase of the corresponding pulse.

In a single carrier system, a THz transceiver system may be implemented using one O/E converter. It may vary depending on the channel environment, but in a multi-carrier system, as many O/E converters as the number of carriers may be required. In particular, in the case of a multi-carrier system using multiple broadbands based on the aforementioned spectrum usage plans, this phenomenon will become more pronounced. In this regard, a frame structure for the multi-carrier system may be considered. A signal down-converted in frequency based on the O/E converter may be transmitted in a specific resource region (e.g., a specific frame). The frequency region of the specific resource region may include a plurality of chunks. Each chunk may consist of at least one component carrier (CC).

### Specific Embodiment of the Present Disclosure

The present disclosure relates to a technology for sharing encrypted data in a wireless communication system. In the present disclosure, encryption may be performed based on homomorphic encryption, and various embodiments for encrypting and managing data based on characteristics of homomorphic encryption are described.

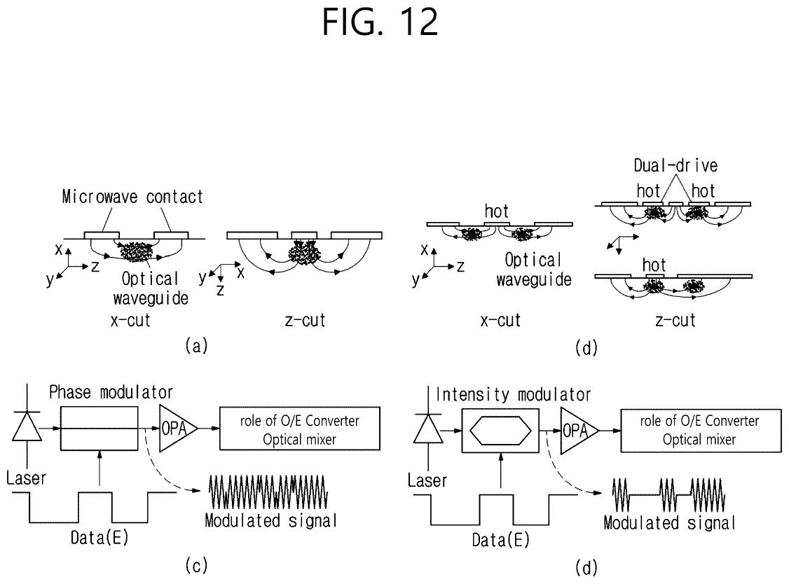

FIG. 13 shows a structure of a system supporting a cloud service based on an embodiment of the present disclosure. Referring to FIG. 13, the system includes UEs 1310, a radio access network (RAN) 1320, a core network (CN) 1330, a cloud server 1340.

The UEs 1310 include at least one of various types of devices used by a user. For example, the UEs 1310 may take various forms such as a smartphone, an HMD, a vehicle, a wearable device, a robot, etc. The RAN 1320 includes at least one base station providing wireless access to the UEs 1310, and the CN 1330 provides various functions for supporting wireless access (e.g., access management, connection management, mobility management, subscriber information management, etc.).

The cloud server 1340 may provide functions that assist communication services in various aspects. For example, the cloud server 1340 may assist operations of the RAN 1320 or the UEs 1310 as an edge cloud, or may store data used or generated by the UEs 1310, the RAN 1320, or the CN 1330 as a storage cloud. Based on an embodiment, the cloud server 1340 may include a central cloud and at least one edge cloud. For example, the cloud server 1340 may provide an intelligent IoT edge environment or may provide a cross-layer application program interface (API). Depending on the implementation, the cloud server 1340 may be one of network nodes included in the CN 1330.

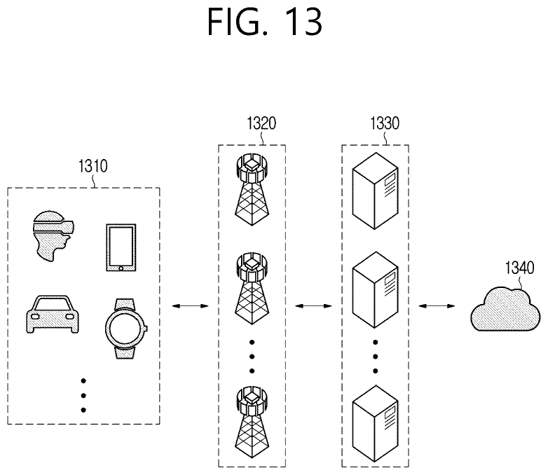

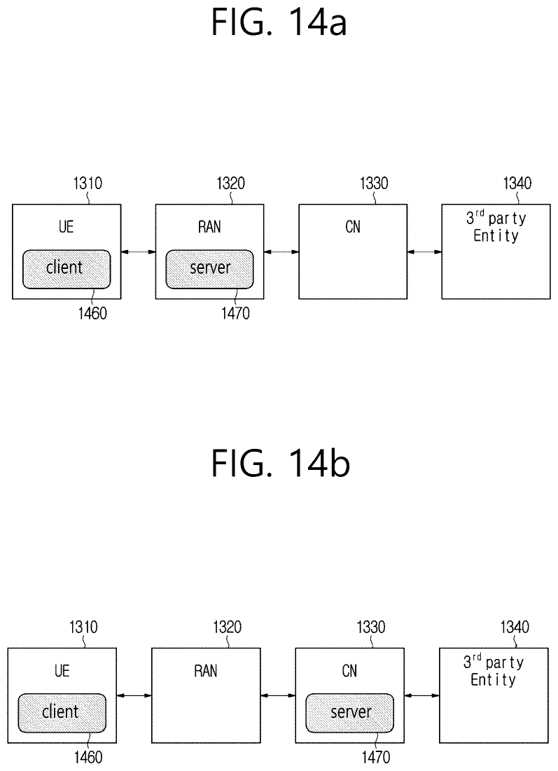

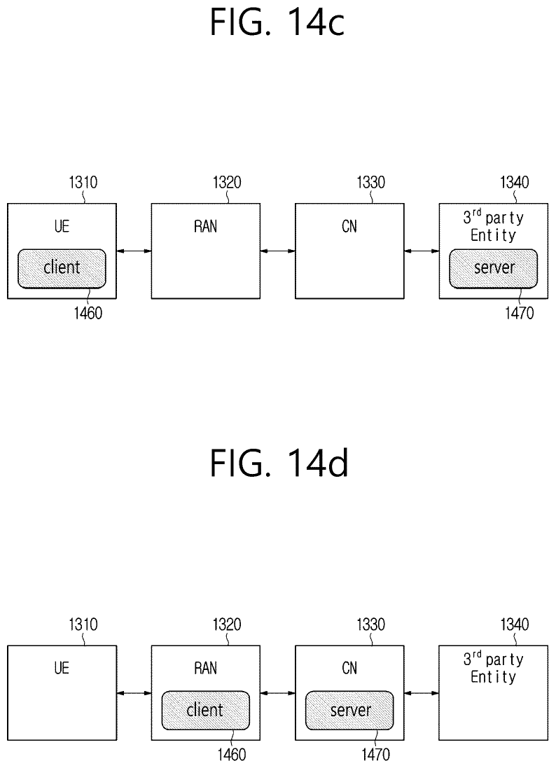

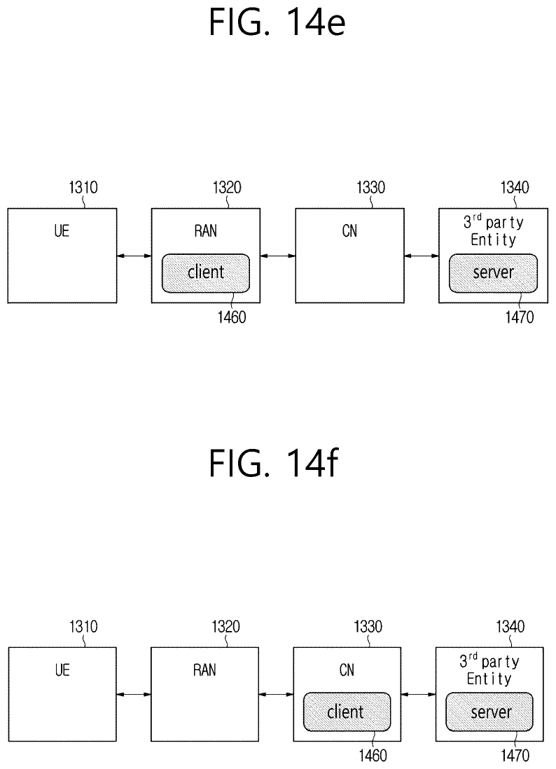

In a system environment such as that of FIG. 13, a service for sharing encrypted data (hereinafter referred to as “data sharing service”) may be provided. The data sharing service operates between a server and a client, where the server refers to an entity that stores and manages data, and the client refers to an entity that uploads/downloads data. Based on various embodiments of the present disclosure, the roles of the server and the client may be performed by entities of the system shown in FIG. 13, and specific examples thereof are shown in FIGS. 14a to 14f below.

FIGS. 14a to 14f show examples of arrangements of entities sharing data based on various embodiments of the present disclosure. FIGS. 14a to 14f show combinations of entities performing roles of a client 1460 and a server 1470.

Referring to FIG. 14a, at least one of the UEs 1310 may function as a client 1460, and at least one of the base stations included in the RAN 1320 may function as a server 1470. In this case, interactions and signaling between the server and the client based on various embodiments described below may be interpreted as procedures between the UE and the base station.

Referring to FIG. 14b, at least one of the UEs 1310 may function as a client 1460, and at least one of the network nodes included in the CN 1320 may function as a server 1470. In this case, interactions and signaling between the server and the client based on various embodiments described below may be interpreted as procedures between the UE and the core network node. In this case, the RAN 1320 may assist a data sharing service between the UE and the core network node. For example, the RAN 1320 may transparently deliver messages related to the data sharing service, or may participate in a procedure for the data sharing service.

Referring to FIG. 14c, at least one of the UEs 1310 may function as a client 1460, and a third-party entity 1440 may function as a server 1470. For example, the third-party entity 1440 may be a cloud server (e.g., the cloud server 1340 of FIG. 13). Here, the third-party entity 1440 is a device belonging to an external network connected through a gateway. In this case, interactions and signaling between the server and the client based on various embodiments described below may be interpreted as procedures between the UE and the third-party entity. In addition, the RAN 1320 and the CN 1320 may assist a data sharing service between the UE and the third-party entity. For example, the RAN 1320 and the CN 1320 may transparently deliver messages related to the data sharing service, or may participate in a procedure for the data sharing service.

Referring to FIG. 14d, at least one of the base stations included in the RAN 1320 may function as a client 1460, and at least one of the network nodes included in the CN 1320 may function as a server 1470. In this case, interactions and signaling between the server and the client based on various embodiments described below may be interpreted as procedures between the base station and the core network node.

Referring to FIG. 14e, at least one of the base stations included in the RAN 1320 may function as a client 1460, and a third-party entity 1440 may function as a server 1470. For example, the third-party entity 1440 may be a cloud server (e.g., the cloud server 1340 of FIG. 13). Here, the third-party entity 1440 is a device belonging to an external network connected through a gateway. In this case, interactions and signaling between the server and the client based on various embodiments described below may be interpreted as procedures between the base station and the third-party entity. In addition, the CN 1320 may assist a data sharing service between the base station and the third-party entity. For example, the CN 1320 may transparently deliver messages related to the data sharing service, or may participate in a procedure for the data sharing service.

Referring to FIG. 14f, at least one of the network nodes included in the CN 1320 may function as a client 1460, and a third-party entity 1440 may function as a server 1470. For example, the third-party entity 1440 may be a cloud server (e.g., the cloud server 1340 of FIG. 13). Here, the third-party entity 1440 is a device belonging to an external network connected through a gateway. In this case, interactions and signaling between the server and the client based on various embodiments described below may be interpreted as procedures between the core network node and the third-party entity.

In the cases of FIGS. 14a to 14c, the client 1460 is included in the UEs 1310. Accordingly, data used by the UEs 1310 or necessary for the operation of the UEs 1310 may be managed and shared by the RAN 1320, the CN 1330, or the third-party entity 1440 including the server 1470. Similarly, in the cases of FIGS. 14d and 14e, the client 1460 is included in the RAN 1320. Accordingly, data used by the RAN 1320 or necessary for the operation of the RAN 1320 may be managed and shared by the CN 1330 or the third-party entity 1440 including the server 1470. Similarly, in the case of FIG. 14f, the client 1460 is included in the CN 1330. Accordingly, data used by the CN 1330 or necessary for the operation of the CN 1330 may be managed and shared by the third-party entity 1440 including the server 1470.

As shown in FIGS. 14a to 14f, the client 1460 and the server 1470 may operate in various combinations of entities. Based on an embodiment, the client 1460 and the server 1470 may be logical entities of a protocol layer defined for data sharing. That is, a protocol layer defined exclusively for data sharing may be used, and the client 1460 and the server 1470 may operate based on procedures defined in the protocol layer for data sharing. Alternatively, based on another embodiment, the client 1460 and the server 1470 may be logical entities based on one of the layers in an already defined protocol stack.

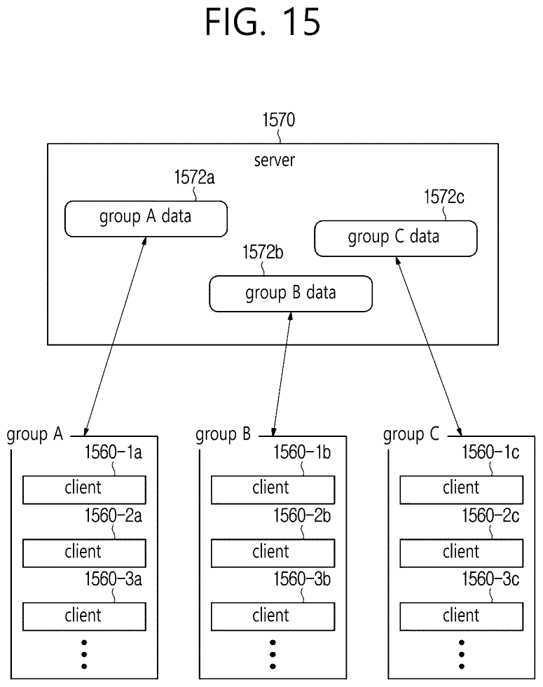

FIG. 15 shows an example of a data sharing environment based on an embodiment of the present disclosure. Referring to FIG. 15, a server 1570 manages data for each of a plurality of groups. Specifically, the server 1570 allocates storage spaces 1572a, 1572b, 1572c for the groups and stores data of the corresponding groups. Clients 1560-1a to 1560-3a, 1560-1b to 1560-3b, 1560-1c to 1560-3c access the server 1570 and may upload or download data to or from the storage space 1572a, 1572b, or 1572c corresponding to the respective group.

Clients 1560-1a to 1560-3a belonging to group A may not have authority to access storage spaces 1572b, 1572c allocated for group B or group C. Alternatively, even if clients 1560-1a to 1560-3a belonging to group A are able to access the storage spaces 1572b, 1572c allocated for group B or group C, they may not hold information required to decrypt the data of group B or group C. That is, the data stored in the storage spaces 1572a, 1572b, 1572c may be encrypted using a key corresponding to each group.

Based on various embodiments, encryption may be based on homomorphic encryption or fully homomorphic encryption (FHE). Therefore, before describing the various embodiments, the present disclosure provides an explanation of homomorphic encryption or fully homomorphic encryption.

Homomorphic encryption is an encryption method that may perform operations without decrypting encrypted data. Homomorphism originates from homomorphism commonly dealt with in mathematics, which refers to a map that preserves operations between two algebraic structures of the same type. That is, homomorphic encryption is a map that maps an element of a plaintext space to an element of a ciphertext space, and is an encryption system that preserves specific operations such as addition and multiplication, etc. The result of operations using ciphertexts becomes a new ciphertext, and the plaintext obtained by decrypting the new ciphertext is identical to the result of the operation on the original data before encryption.

For example, the result of adding ciphertexts Enc(M₁) and Enc(M₂), which are obtained by homomorphically encrypting plaintexts M₁ and M₂, is the same value as ciphertext Enc(M₁+M₂) corresponding to (M₁+M₂). Likewise, the result of multiplying ciphertexts Enc(M₁) and Enc(M₂), which are obtained by encrypting plaintexts M₁ and M₂, is the same value as ciphertext Enc(M₁×M₂) corresponding to (M₁×M₂). As such, since ciphertexts based on homomorphic encryption include the same result as a ciphertext of values obtained by adding or multiplying plaintexts, decrypting the ciphertext derives the same value as the result of adding or multiplying the plaintexts themselves.

All Boolean function operations of a computer may be expressed by exclusive OR (XOR) and logical AND. Therefore, if the property of homomorphic encryption that enables addition and multiplication without decrypting encrypted data is extended, various data processing such as statistical operations or machine learning, etc., may be easily performed without decrypting the encrypted data.

Furthermore, homomorphic encryption may be applied to a database system. When a data owner requests data analysis but does not want to expose the data, the data owner may provide homomorphically encrypted data to a data analyst. The data analyst may generate a ciphertext of the analysis result through homomorphic encryption operations and deliver it to the data owner. At this time, if only the data owner has the secret key, the data analyst may not know the analysis result obtained, and only the data owner having the secret key may decrypt it. Therefore, it becomes possible to obtain analysis results without exposing one's own data.

The above-described homomorphic encryption may be classified into partial homomorphic encryption, somewhat homomorphic encryption, and fully homomorphic encryption (FHE), depending on the type of operations that may be performed in the encrypted state and the number of possible operations. Widely used public key cryptosystems such as the Rivest Shamir Adleman (RSA) algorithm and the ElGamal algorithm may also be regarded as partial homomorphic encryption since multiplication operations may be performed in the encrypted state. Meanwhile, somewhat homomorphic encryption refers to homomorphic encryption in which algebraic operations are no longer possible after a certain number of operations due to incompleteness of algebraic operations.

In 2009, Gentry announced the first fully homomorphic encryption that enables unlimited repetition of arbitrary operations in an encrypted state by adding an operation called bootstrapping. However, in the case of the first generation of fully homomorphic encryption, security was proven but it was difficult to implement efficiently. Encryption and decryption based on the first generation of fully homomorphic encryption is performed based on the following procedure. In encryption, a message is encoded as a=m+2e on m∈{0,1}R^{d}. At this time, e is a random vector having coefficients in {0, ±1}, and the ciphertext is

$$c = a - ( ⌈ a {B}_{pk}^{- 1} ⌋ {B}_{pk} ) .$$

Here, ┌⋅┘ denotes a bilinear operation, and

$$P ( B ) = \{ {\sum }_{i = 1}^{k} {x}_{i} {b}_{i} : {x}_{i} ∈ [ - \frac{1}{2} , \frac{1}{2} ) \} .$$

In decryption,

$${a}^{′} = c - ( ⌈ c {B}_{sk}^{- 1} ⌋ {B}_{sk} )$$

is calculated, and then mod 2 operation is performed. That is, the plaintext is the result of a′ mod 2.

In 2011, the BGV11 scheme was announced by Brakerski-Gentry-Vaikuntanathan. The BGV11 scheme improved the number of possible multiplication operations from a linear level of ciphertext length to an exponential level by applying a method to reduce the size of noise generated during multiplication without bootstrapping. The operation that reduces the size of the noise is a process called modulus/key-switching, and the scheme that introduced this process is referred to as the second-generation homomorphic encryption.

The BGV scheme based on ring-learning with errors (RLWE) operates based on the following operation. In the following description, d is a power of 2, modulus q is an odd positive integer, x is an error distribution on R=Z[x]/(x^{d}+1), B denotes the bound of the length of elements output by the error distribution x. For some integer p, R_{p=Z}_{ₚ}[x]/(x^{d}+1) may be defined. In key generation, a security parameter λ and a random value s∈χ are selected, and a secret key

$$sk = s = ( 1 , s ) ∈ {R}_{q}^{2}$$

is determined. a′∈R_{q} is generated, and b=a′s+2e is computed. Here, e is an error randomly selected from χ. The public key is pk=a=(b, −a′) and <a,s>=2e. In encryption, a message m∈R₂ is transformed into a vector

$$m = ( m , 0 ) ∈ {R}_{q}^{2}$$

and r, e₀, e₁∈χ are randomly selected. Then, the ciphertext is determined as c=m+2 (e₀, e₁)+ar. Here,

$$c = ( {c}_{0} , {c}_{1} ) = ( m + 2 {e}_{0} + br , 2 {e}_{1} - {a}^{′} r ) ∈ {R}_{q}^{2} .$$

In decryption, the secret key

$$s ∈ {R}_{q}^{2}$$

and the ciphertext

$$c ∈ {R}_{q}^{2}$$

are input values, and <c, s>=c₀+c₁s=m+2e₀+2e₁s+2er is computed. By the mod operation, the plaintext is determined as ((m+2 (e₀+e₁s+er))mod q) mod 2=m. In homomorphic multiplication, addition is performed element by element, and it does not matter if the sum does not exceed the modulus q. Multiplication is performed as

$$< c , s > \cdot < {c}^{′} , s > = ( {c}_{0} , {c}_{1} s ) ( {c}_{0}^{′} + {c}_{1}^{′} s ) = {c}_{0} {c}_{0}^{′} + ( {c}_{0} {c}_{1}^{′} + {c}_{1} {c}_{0}^{′} ) s + {c}_{1} {c}_{1}^{′} s 2 = {d}_{0} + {d}_{1} s + {d}_{2} {s}^{2} .$$

The new cyphertext (d₀, d₁, d₂) new secret key (1, s, s²). In the BGV scheme, to solve the problem that the secret key increases whenever multiplication is performed, a key switching method was introduced. Key switching changes d₂s² generated after multiplication on the ciphertext Encₛ(s²) for s² to c̅₀+c̅₁s, and transforms the ciphertext into a new ciphertext \tilde{c}₀+\tilde{c}₁s that encrypted the same plaintext. In this case, (β, −α)=(s²+2e++a′rs, 2e₁−a′r)≅(s²+αs, −α).

In 2013, Gentry-Sahai-Water introduced a technique that further reduces the noise in the multiplication process and eliminates the relinearization process, which requires high computational cost. Homomorphic encryption utilizing this technique is referred to as third-generation homomorphic encryption. In particular, the fast fully homomorphic encryption (TFHE) scheme of Chillotti-Gama-Georgieva-Izabachene and the FHEW scheme of Ducas-Micciancio, which enables very fast bootstrapping in exchange for restricting the plaintext to 1 bit, belong to third-generation homomorphic encryption.

The TRLWE scheme or the TFHE scheme operates based on the following operation. In the following description, d is a power of 2, R=Z[x]/(x^{d}+1), T=R[x]/(x^{d}+1) mod 1, R₂=F₂[x]/(x^{d}+1) are defined. Any element selected from R₂ is a polynomial of degree less than or equal to d with coefficients of {0,1}. In key generation, for a security parameter λ, a secret key

$$s ∈ {R}_{2}^{n}$$

is determined. In encryption, for a message m∈T, an error parameter α, in the case of a random mask a∈Tⁿ, a small error e∈χ, the ciphertext is determined as c:=(a, s·a+., +e)∈Tₙ×T. Here, χ follows a B-bounded distribution. In decryption, a secret key

$$s ∈ {R}_{q}^{2}$$

and a ciphertext c∈Tⁿ⁺¹ are taken as input values, and a linear κ-Lipschitz function ψₛ of the ciphertext is computed. ψₛ:Tⁿ×T→T, ψₛ(a,b)=b−s·a. The function ψₛ(c) has a value close to the actual message, and ψₛ(c)=s·a+m+e−s·a=m+e. In homomorphic linear combination, when there exist p ciphertexts c₁, . . . , cₚ encrypted with the same key s and polynomials f₁, . . . , fₚ with integer coefficients, a new ciphertext

$$c = {\sum }_{i = 1}^{p} {f}_{i} \cdot {c}_{i}$$

may be obtained by a linear combination of the ciphertexts. In this case, the new ciphertext is

$${Dec}_{s} ( c ) = {\sum }_{i = 1}^{p} {f}_{i} \cdot {Dec}_{s} ( {c}_{i} )$$

and maintains ∥e∥_{∞}<1/4.

In 2017, Cheon-Kim-Kim-Song announced a homomorphic encryption scheme named homomorphic encryption for arithmetic of approximate numbers (HEAAN), which enables a third operation, rounding, in addition to addition and multiplication. HEAAN uses the Cheon-Kim-Kim-Song (CKKS) scheme.

The CKKS scheme operates based on the following operations. For some positive integer q, R_{q}:=R/qR is a cyclic ring of Rmod q. χₛ, χᵣ, χₑ represent distributions on R with polynomials that contain small coefficients. The modulus Q and the ring degree n may be determined in advance prior to key generation. In key generation, a secret polynomial s←χₛ is selected. A random value a is selected from R_{Q}, a′ is selected from R_{PQ}, and e, e′ ←χₑ is randomly selected. At this time, a secret key is

$$sk ← ( 1 , s ) ∈ {R}_{Q}^{2} ,$$

and a public key is determined as

$$pk ← ( b = - a \cdot s + e , a ) ∈ {R}_{Q}^{2} ,$$

an evaluation key as

$$evk ← ( {b}^{′} = - {a}^{′} ← s + {e}^{′} + P \cdot {s}^{2} , {a}^{′} ) ∈ {R}_{PQ}^{2} .$$

In encryption, to encrypt a given message m∈R, a random polynomial r←χᵣ is selected, and

$$ct ← ( {c}_{0} = r \cdot b + {e}_{0} + m , {c}_{1} = r \cdot a + {e}_{1} ) ∈ {R}_{Q}^{2}$$

is computed. In decryption, an inner product operation <ct,sk>→m′ between the secret key and the ciphertext is performed. Specifically, An operation such <ct,sk>=<(r·B+e₀+m,r·a+e₁)·(1,s)>=r·b+e₀+m+s·(r·a+e₁)=r·(−a·s+e)+e₀+m+s·(r·a+e₁)=m′≅m may be performed. In homomorphic operations, when two ciphertexts ct=(c₀, c₁) and

$${ct}^{′} = ( {c}_{0}^{′} , {c}_{1}^{′} )$$

are given, homomorphic addition includes element-wise addition

$${ct}_{add} ← ct + {ct}^{′} ∈ {R}_{Q}^{2} .$$

Homomorphic multiplication includes an element-wise multiplication operation

$$( {d}_{0} , {d}_{1} , {d}_{2} ) = ( {c}_{0} {c}_{0}^{′} , {c}_{0} {c}_{1}^{′} + {c}_{1} {c}_{0}^{′} , {c}_{1} {c}_{1}^{′} ) mod Q$$

for two ciphertexts and an operation that removes the squared term. In summary, the multiplication operation is as follows:

$${ct}_{mult} ← ( {d}_{0} , {d}_{1} ) + ⌈ {P}^{- 1} \cdot {d}_{2} \cdot evk ⌋ ∈ {R}_{Q}^{2} .$$

Conventional homomorphic encryption may also perform a rounding operation, but it requires a very complicated operation equivalent to bootstrapping. The CKKS scheme processes the operation as fast as the addition level, thereby having greatly improved arithmetic performance. In addition, while conventional homomorphic encryption restricts plaintext to be encrypted to a bit or an integer, HEAAN enables homomorphic encryption and computation in an encrypted state for real numbers, thereby providing higher applicability.

TABLE 3

| Gener- | | | Unit of | ISO |
|---|---|---|---|---|
| ation | Year | Feature | operation | standard |
| 1st | 2009 | First fully homomorphic | Bit | |
| 2nd | 2011 | Applicable to real data | Integer | BGV, BFV |
| 3rd | 2013 | Efficient for small data | Bit | TFHE |
| | | processing | | |
| 4th | 2016 | Homomorphic encryption | Real number | CKKS |
| | | supporting arithmetic | (integer) | |
| | | up to real numbers | | |

The aforementioned homomorphic encryption technology may be applied in various fields.

For example, homomorphic encryption may be applied to IoT in fog or edge computing. Fog computing was initially proposed by CISCO and started to deploy scalable large-scale IoT, and in cellular networks of 5G/6G communication, it was developed into the concept of edge computing. In fog computing, a layer between IoT devices and cloud services is defined as close as possible to devices to process data in advance. In order to reduce the bandwidth consumption and latency of IoT applications, it is important to perform data processing tasks in advance close to the device. In the above scenario, homomorphic encryption may provide a privacy protection function since data pre-processing is performed in an encrypted state. However, there are some characteristics to be considered when applying homomorphic encryption in the field of fog or edge computing. Each piece of data must be an event-based packet generated by a specific device, and each piece of data must be moved through the network according to the data generation rate of the device. That is, data must be processed per packet. Therefore, data processing does not allow delay, and the scope of data processing tasks is limited to the information included in a single data packet (relevance/category evaluation, format, coding, expansion/compression, filtering, threshold value, real-time alarm evaluation, etc.). A smart city provides an example of how fog computing and homomorphic encryption may be connected, and a wide range of applications such as intelligent transportation, efficient resource distribution such as lighting, water and waste management, safety and security, or environmental monitoring may be considered. These applications have common requirements, and a network is constructed by being deployed to large-scale IoT devices composed of small sensors that continuously supply data to a smart city data collector. At this time, the fog layer preprocesses data inside an intermediate gateway, and the data preprocessing process may have scalability. At this time, homomorphic encryption may be applied for privacy protection. Specifically, a sensor may encrypt data with a public key of a data collector, and the encrypted data may be processed inside the fog layer, but decryption may be processed only inside the data collector. This approach may prevent data leakage inside the fog node as well as provide a privacy protection function for the data collector. Despite the above advantages, it is difficult to apply homomorphic encryption to IoT devices due to the problems of computational complexity and ciphertext size. If the size of ciphertext becomes much larger than plaintext, the overhead of communication increases, and the problem of complex computation causes computational delay, so the situation becomes worse due to the limited hardware function and computational capacity of IoT devices and the bandwidth constraints of IoT communication standards. As an alternative, a hybrid protocol combining homomorphic encryption and symmetric key encryption (SKE) has been proposed. In hybrid homomorphic encryption (HHE), an IoT device performs symmetric key encryption with a random key, and encrypts the symmetric key with a homomorphic encryption public key of a data collector. In the middle between an IoT node and a data collector, a fog node may perform key switching to convert data encrypted with a symmetric key into homomorphically encrypted data and then perform homomorphic operations. This method has the advantage of moving the problems of computation and ciphertext expansion from the IoT device to the fog node. At this time, the IoT device only needs to perform encryption by a symmetric key encryption method such as AES. Fog or edge computing may not be limited to smart city scenarios but may be extended to new fields such as industrial IoT and Internet of Medical Things (IoMT). However, when data is encrypted with a recipient's public key, the hybrid protocol is effective, but in a situation where an IoT device encrypts with its own public key and communication must be processed bidirectionally, there is a problem that the size of ciphertext increases.

For example, homomorphic encryption may be applied to cloud computing. While fog computing is a distributed infrastructure, cloud computing is a system in which data processing is basically in the form of responses to queries, and large-scale data of various applications are concentrated. Homomorphic encryption may be an effective component for privacy protection in cloud computing.

For example, homomorphic encryption may be applied to homomorphic proxy re-encryption. Most homomorphic encryptions only support homomorphic operations for ciphertexts encrypted with the same public key, so ciphertexts of different users must be transformed into ciphertexts encrypted with the same key. This is called homomorphic proxy re-encryption (HPRE). Proxy re-encryption itself is a technology used in cloud computing with conventional cryptographic schemes that is not homomorphic encryption, and it was used to transform a ciphertext of a person who wants to delegate into a ciphertext that another user (e.g., the delegate) may decrypt, and the delegate may decrypt the ciphertext even without the secret key of the delegator. That is, the proxy may transform a ciphertext without knowing the plaintext or the user's key. Homomorphic proxy re-encryption may achieve additional effects because the cloud may perform homomorphic operations on the transformed ciphertext. Gentry's proposed method is as follows. First, the secret key is encrypted with the public key of the delegatee. Then, the delegator encrypts data with the delegator's own public key. Thereafter, the proxy performs necessary operations as a decryption circuit and re-encrypts the ciphertext with the delegatee's public key. Gentry's method had a vulnerability in that, if the delegatee and the proxy colluded, they could obtain the delegator's secret key, and several homomorphic proxy re-encryption techniques based on key switching technology have resolved this problem.

For example, homomorphic authenticated encryption (HAE) may be applied. When a cloud user pays for a particular service or data integrity is very important, a guarantee that the data has been processed correctly may be required. The cloud, even if not specifically malicious, may provide incorrect data to reduce or avoid much of the computation required to process homomorphically encrypted data. At this time, the user should be able to verify whether the decrypted data has properly performed the command requested by the user, and satisfying this requirement is HAE. HAE may be obtained by combining homomorphic encryption and homomorphic authentication (HA), specifically, the user attaching a homomorphic signature together with the ciphertext. Such a signature may be used, similarly to a ciphertext, as a valid signature for data processed through homomorphic operations. In addition, if HE and HA satisfy chosen plaintext attack security, homomorphic encryption and authentication (HEA) satisfies chosen ciphertext attack-1 (CCA-1).

For example, homomorphic encryption may be applied to multiparty computation. Using homomorphic encryption, computations previously performed on a personal PC may be carried out by the cloud. However, when multiparty computation involving interactions among multiple parties is performed, several considerations exist. In particular, secure multiparty computation, which performs computations without leaking information about each party's input values and without knowing the input values of other parties except for values inferred from the output, is suitable for applying homomorphic encryption. Secure multiparty computation has already existed based on secret sharing technology and garbled circuits, and it is structured to follow a preprocessing model in which computation is divided into two stages. The first stage is the generation of secret shares or garbled circuits, which is performed before the parties' input values are defined, thereby serving as an encryption preparation stage that increases the speed of the second stage. The second stage is the step in which the input values of the parties are defined and each computes the circuit. Although somewhat less efficient than previous approaches, one of the good methods of performing secure multiparty computation is to use multi-key fully homomorphic encryption (Multi-Key FHE, MKFHE). Secure multiparty computation using MKFHE is performed in two rounds of communication. In the first round, each party encrypts input values with multiple keys and broadcasts the ciphertexts to all parties. Thereafter, each party computes the circuit using homomorphic operations. In the second round, each party broadcasts a partially decrypted share of the result. Each party combines its own partial decryption value and the partial decryption fragments of other parties to obtain an output value. However, the multi-party computation of this MKFHE scheme requires the decryption fragments of all parties who hold secret key fragments, and only then may decryption succeed, and even if only one party fails to deliver its decryption fragment, the protocol itself results in a failure. The above-mentioned problem may be solved with a homomorphic encryption that applies threshold decryption, for example, TMFHE (threshold MKFHE), and by using TMFHE, a small number of parties who exceed the threshold value may perform decryption.

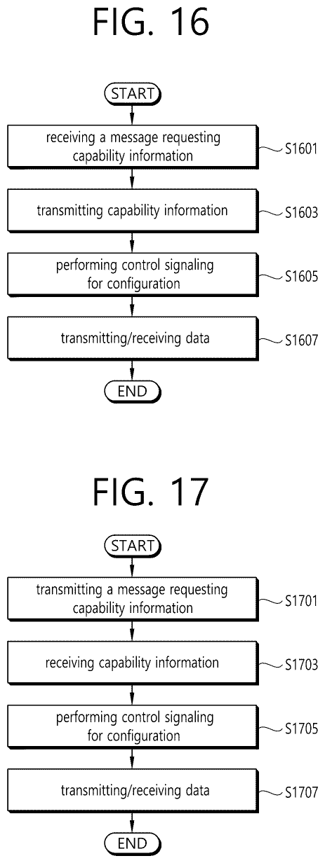

FIG. 16 shows an example of a procedure of using shared data based on an embodiment of the present disclosure. FIG. 16 shows an operation method of a first device (e.g., a UE) including a client, and an upper node including a server (e.g., a base station, a core network node, or a third-party entity) is referred to as a second device.

Referring to FIG. 16, in step S1601, a device receives a message requesting capability information. During a process in which a first device accesses a second device and establishes a connection, or after establishing the connection, the first device may receive from the second device a message inquiring capability information of the first device. The message inquiring capability information may include information indicating a scope of capability information required (e.g., RAT, filter, etc.). However, based on another embodiment, the first device may transmit capability information without a request, and in this case, this step may be omitted.

In step S1603, the first device transmits capability information. In other words, the first device transmits a message including capability information. The capability information may include information related to capabilities associated with communication of the first device. Based on an embodiment, the capability information may include information related to encryption of data. For example, the information related to encryption of data may include information about supported encryption schemes. Based on an embodiment, the first device may report, through the capability information, that encryption based on homomorphic encryption is supported.

In step S1605, the first device performs control signaling for configuration. For example, the first device may perform control signaling with the second device for configuration required to perform communication. Specifically, the first device may establish connections in various layers, set operation modes, set resources for operation (e.g., slice, carrier, bandwidth part (BWP), flow, channel, etc.), or configure services. Alternatively, the first device may receive physical layer parameters necessary for transmitting and/or receiving signals, for example, power, modulation and coding scheme (MCS), scheduling information, hybrid automatic repeat request (HARQ) parameters, etc.

In step S1607, the first device transmits and/or receives data. That is, the first device may transmit and/or receive a signal including data, for example, through resources allocated via control signaling, based on the control signaling. In this case, based on an embodiment, the first device may transmit or receive data shared through a data sharing service. In this case, the first device may use an encryption scheme based on homomorphic encryption for the data sharing service. For example, the first device may encrypt data to be transmitted based on homomorphic encryption. As another example, the first device may decrypt data to be received based on homomorphic encryption.

FIG. 17 shows an example of a procedure for managing shared data based on an embodiment of the present disclosure. FIG. 17 shows an operation method of a second device (e.g., a base station) including a server, and a lower node (e.g., a UE) including a client is referred to as a first device.

Referring to FIG. 17, in step S1701, the second device transmits a message requesting capability information. During a process in which a first device accesses a second device and establishes a connection, or after establishing the connection, the second device may transmit a message inquiring capability information of the first device to the first device. The message inquiring capability information may include information indicating a scope of required capability information (e.g., RAT, filter, etc.). However, based on another embodiment, the first device may transmit capability information without a request, and in this case, this step may be omitted.

In step S1703, the second device receives capability information. In other words, the second device receives a message including capability information of the first device. The capability information may include information related to capabilities associated with communication between the first device and the second device. Based on an embodiment, the capability information may include information related to encryption of data. For example, the information related to encryption of data may include information on supported encryption schemes. Based on an embodiment, the second device may confirm that the first device supports encryption based on homomorphic encryption through the capability information.

In step S1705, the second device performs control signaling for configuration. For example, the second device may perform control signaling with the second device for configuration required to perform communication. Specifically, the second device may establish connections in various layers, set operation modes, set resources for operation (e.g., slices, carriers, BWP, flows, channels, etc.), or configure services. Alternatively, the second device may transmit physical layer parameters required to transmit and/or receive signals, for example, power, MCS, scheduling information, HARQ parameters, etc.

In step S1707, the second device transmits and/or receives data. That is, the second device may transmit and/or receive a signal including data based on control signaling, for example, through resources allocated by the control signaling. In this case, based on an embodiment, the second device may transmit or receive data shared through a data sharing service. In this case, the second device may use an encryption scheme based on homomorphic encryption for the data sharing service. For example, the second device may receive data encrypted based on homomorphic encryption, classify it by group, and store it. In another example, the second device may convert data into a decryptable state and transmit it based on a request from the first device including the client.

As in the embodiments described with reference to FIGS. 16 and 17, the second device may provide a data sharing service, and the first device may use the data sharing service. For the data sharing service to be operated between the first device and the second device, various procedures and corresponding signaling or data transmission/reception are required. Specifically, the procedures related to the data sharing service include an initialization procedure, a data upload/download procedure, a key refreshing procedure, a member change procedure, a group splitting procedure, a group merging procedure, etc. For example, when the service is first initiated, after the initialization procedure including group creation, key generation, etc., is performed, the data upload and/or download procedure may be performed. In addition, based on the addition/removal of members, a group member change procedure may be performed, and if necessary, a group merging procedure or a group splitting procedure may be performed, and accordingly, the generated keys or the stored data may be updated.

In order to perform the aforementioned procedures, signaling of messages related to the data sharing service may be required. Based on an embodiment, signaling for the data sharing service may be included in the control signaling of step S1605 and step S1705. Based on another embodiment, signaling for the data sharing service may be included in the data transmission/reception of step S1607 and step S1607. That is, since the data sharing service is a service conducted in the relationship between a server and a client, messages for the configuration related to the data sharing service may be treated as control signals or as payloads.

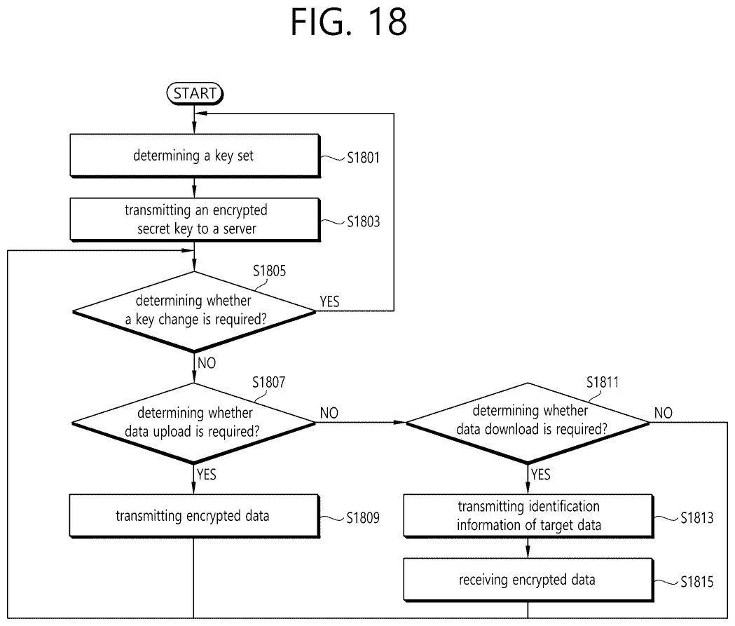

FIG. 18 shows an example of a procedure for using shared data based on homomorphic encryption based on an embodiment of the present disclosure. FIG. 18 shows an operation method of a first device (e.g., a UE, base station, or core network node) including a client, and an upper node (e.g., a base station, core network node, or third-party entity) including a server is referred to as a second device.

Referring to FIG. 18, in step S1801, the first device determines a key set. Here, the key set includes keys necessary for performing encryption based on homomorphic encryption in a data sharing service, and may include, for example, at least one of a reference public key, a public key for encrypting data, and a secret key for decrypting data. To this end, although not shown in FIG. 18, the first device may acquire a public key of at least one other member, and may determine the reference public key by using the public key of the first device and the public key of at least one other member.

In step S1803, the first device transmits an encrypted secret key to a server. For example, the first device may transmit the encrypted secret key to the second device functioning as a server for initialization of the data sharing service. At this time, the secret key is not transmitted in a plaintext state for data protection by encryption, but is transmitted in a ciphertext state. For example, the secret key may be encrypted by using the public key of the first device, the public key of at least one other member. That is, the first device transmits ciphertexts as many as the number of members. The encrypted secret key transmitted from the first device may be used in the server to determine a switching key.

In step S1805, the first device determines whether a key change is required. If the key change is required, the first device returns to step S1801. That is, by performing step S1801 and step S1803, the first device updates at least one of the keys included in the key set and transmits the encrypted secret key to the server based on the at least one updated key. For example, when a member of the group is changed or key refreshing is instructed, it may be determined that the key change is required.

In step S1807, the first device determines whether data upload is required. In other words, the first device determines whether data to be shared occurs within the group. The data to be shared may occur by progress of a related application, progress of a related procedure, and the like. For example, when information required to be shared with members within the group is generated during operation of the first device, the first device may determine that the data upload is required. If the data upload is not required, the first device proceeds to step S1811.

If the data upload is required, in step S1809, the first device transmits encrypted data. Here, the data may be encrypted by using a reference public key. In other words, the first device encrypts the data by using the reference public key and transmits an indication for upload of the shared data and the encrypted data to the server. Here, the indication may be expressed explicitly or implicitly. As such, the data is uploaded in a ciphertext state rather than a plaintext state, and thereby, the original of the data is not stored in the server providing the data sharing service.

In step S1811, the first device determines whether data download is required. In other words, the first device determines whether acquisition of the data shared within the group stored in the server is required. The acquisition of the shared data may be required by progress of a related application, progress of a related procedure, and the like. For example, when viewing of information generated by another member in the group or viewing of the data uploaded by the first device is required during operation of the first device, the first device may determine that the data download is required. If the data download is not required, the first device proceeds to step S1805.

If the data download is required, in step S1813, the first device transmits identification information of target data. That is, for downloading the data, the first device requests the server to transmit the data to be acquired, and transmits a message including an indication for downloading the shared data and identification information (e.g., tag) for data identification in the server. Here, the indication may be expressed explicitly or implicitly.

In step S1815, the first device receives encrypted data. In other words, the first device receives shared data from a second device functioning as a server. At this time, the received data is in a ciphertext state and is in a key switched state so as to be decryptable by the secret key of the first device. Accordingly, the first device may acquire original data, that is, data in a plaintext state, by decrypting the encrypted data by using the secret key of the first device.

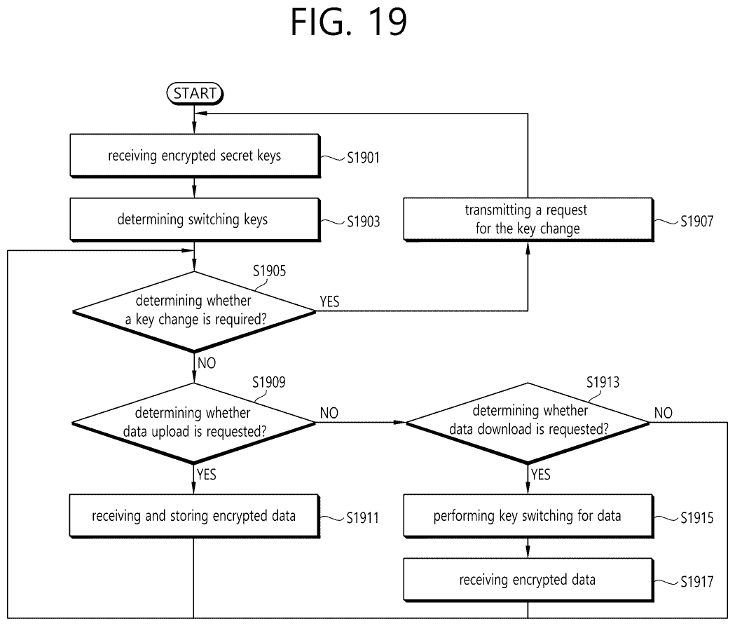

FIG. 19 shows an example of a procedure for managing shared data based on homomorphic encryption based on an embodiment of the present disclosure. FIG. 19 shows an operation method of a second device including a server (e.g., a base station, a core network node, or a third-party entity), and a lower node including a client is referred to as a first device.

Referring to FIG. 19, in step S1901, the second device receives encrypted secret keys. For initialization of the data sharing service, the second device receives encrypted secret keys from members of the group. At this time, the secret key is not transmitted in a plaintext state for data protection by encryption, but is transmitted in a ciphertext state. For example, the secret key of a specific member may be encrypted by using the public key of the member transmitting the secret key and at least one public key of the other member. That is, with respect to one member, ciphertexts as many as the number of members including the secret key of the corresponding member are received.

In step S1903, the second device determines switching keys. The switching key is used to change uploaded data into a state decryptable by a secret key of a specific member. The switching key is determined based on ciphertexts including the secret key of the corresponding member. That is, the second device may generate the switching key for the corresponding member by performing a homomorphic operation on the ciphertexts including the secret key of the corresponding member. The switching key is generated for each member.

In step S1905, the second device determines whether a key change is required. The key change may be performed for maintaining security. The procedure of changing the key may be referred to as a key refreshing procedure. The key change may be performed due to various causes such as a change of the group (e.g., member addition, member removal, group division, group merging, etc.), leakage of a key, and the like.

If the key change is required, in step S1907, the second device transmits a request for the key change. In other words, the second device transmits a message requesting or instructing the key change to members of the group, that is, to the first devices. The message may include an indication for the key change and a cause of the change. Here, the indication may be expressed explicitly or implicitly. Then, the second device proceeds to step S1901.

If the key change is not required, in step S1909, the second device determines whether data upload is requested. The request for data upload may be determined by detecting an indication for upload from the first device. Here, the indication may be expressed explicitly or implicitly.

If the data upload is requested, in step S1911, the second device receives and stores encrypted data. The encrypted data may be received together with an indication for the upload. The data is received in a state encrypted by using the reference public key. Accordingly, even if the data is uploaded, the original of the data is not stored in the second device. Then, the second device stores the received data in storage space allocated to the group.

If the data upload is not requested, in step S1913, the second device determines whether data download is requested. The request for data download may be determined by detecting an indication for upload from the first device. Here, the indication may be expressed explicitly or implicitly. Together with the indication, identification information (e.g., tag) for the data may be received. If the data download is not requested, the second device proceeds to step S1905.

If the data download is requested, in step S1915, the second device performs key switching for the data. The second device identifies the data requested for download based on the identification information received from the first device requesting the download and converts the identified data into a state decryptable by the secret key of the first device. To this end, the second device identifies the switching key of the first device and performs key switching for the data by using the identified switching key. Even when the key switching is performed, the data still remains in a ciphertext state.

In step S1915, the second device transmits encrypted data. In other words, the second device transmits the shared data to the first device. At this time, the data is in a ciphertext state and is in a state decryptable by the requester's secret key through key switching.

Based on the foregoing embodiments, data may be encrypted and shared based on homomorphic encryption. Accordingly, the data may be shared securely. Hereinafter, the present disclosure will describe more specific embodiments relating to various procedures of sharing and encryption of data.

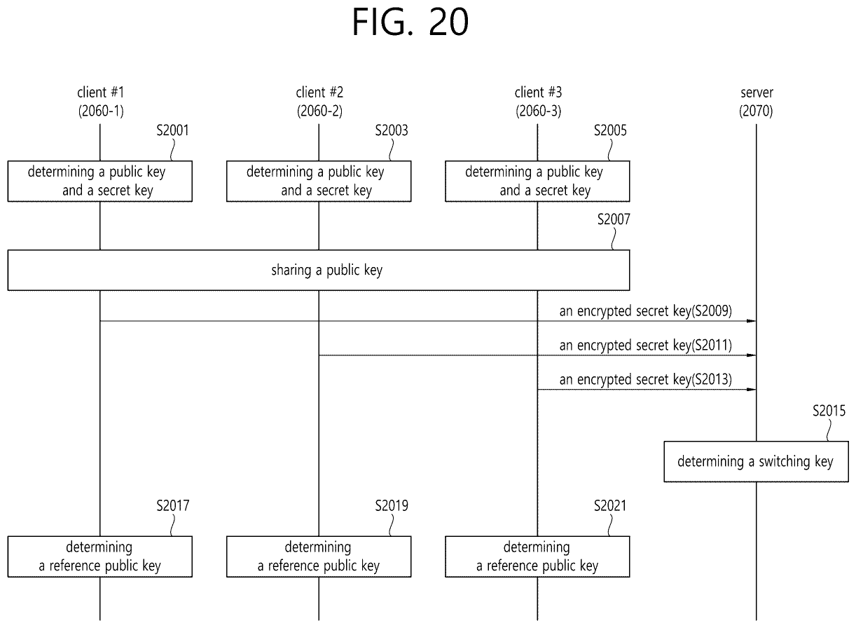

FIG. 20 shows an example of an initialization procedure for sharing encrypted data based on homomorphic encryption based on an embodiment of the present disclosure. In FIG. 20, a first client to a third client 2060-1 to 2060-3 belong to the same group and share data. FIG. 20 shows a case where three clients 2060-1 to 2060-3 form one group, but the number of members included in one group may be two or less or four or more. In addition, when multiple groups are created, initialization for each group may be performed by performing procedures described below for each group.

Referring to FIG. 20, in step S2001, step S2003, step S2005, each of the clients 2060-1 to 2060-3 determines a public key and a secret key for encryption based on homomorphic encryption. To determine the public key and the secret key, the clients 2060-1 to 2060-3 use a predefined key generation rule, and based on the key generation rule, may determine the public key and the secret key based on encryption parameters. For example, the encryption parameters may be determined based on an identifier of an entity (e.g., UE) including the clients 2060-1 to 2060-3. Based on another embodiment, the public key and the secret key may be determined by an entity other than the clients 2060-1 to 2060-3, and in this case, step S2001, step S2003, step S2005 may be understood as operations of checking the public key and the secret key provided from the other entity.

In step S2007, the clients 2060-1 to 2060-3 share public keys. Since a reference public key for encryption based on homomorphic encryption is generated by using the public keys of the sharers, sharing of the public keys is required. Accordingly, each of the clients 2060-1 to 2060-3 transmits information related to the public key (e.g., public key, encryption parameters, etc.) to other clients and receives information related to the public keys of the other clients. Based on another embodiment, the public keys may be shared by another method, and in this case, step S2007 may be omitted.

In step S2009, step S2011, step S2013, each of the clients 2060-1 to 2060-3 transmits an encrypted secret key to the server 2070. Here, the secret key is encrypted by using the public key of each of the clients 2060-1 to 2060-3 and then transmitted. For example, the first client 2060-1 may transmit control information or data including a secret key of the first client 2060-1 encrypted by using the public key of the first client 2060-1, a secret key of the first client 2060-1 encrypted by using the public key of the second client 2060-2, and a secret key of the first client 2060-1 encrypted by using the public key of the third client 2060-3. Similarly, the second client 2060-2 transmits control information or data including a secret key of the second client 2060-2 encrypted by using the public key of each of the clients 2060-1 to 2060-3, and the third client 2060-3 may transmit control information or data including a secret key of the third client 2060-3 encrypted by using the public key of each of the clients 2060-1 to 2060-3.

In step S2015, the server 2070 determines a switching key. The switching key is generated per group. The switching key is a key used to transform encrypted data so that it may be decrypted by using a secret key of each of the clients 2060-1 to 2060-3. The switching key is determined based on secret keys of all the clients 2060-1 to 2060-3 in the group encrypted with the public key of the client that will decrypt the data. Accordingly, the server 2070 may determine a switching key for each of the clients 2060-1 to 2060-3 by performing a homomorphic addition operation on at least one of the encrypted secret keys received in step S2009, step S2011, step S2013. For example, the server 2070 may determine a switching key for the first client 2060-1 by homomorphically adding the secret key of the first client 2060-1 encrypted with the public key of the first client 2060-1, the secret key of the second client 2060-2 encrypted with the public key of the first client 2060-1, the secret key of the third client 2060-3 encrypted with the public key of the first client 2060-1.

In step S2017, step S2019, step S2019, each of the clients 2060-1 to 2060-3 determines a reference public key. The reference public key is determined by adding all public keys of the clients 2060-1 to 2060-3 in the group. For example, the first client 2060-1 may determine the reference public key by adding the public key of the first client 2060-1, the public key of the second client 2060-2, the public key of the third client 2060-3. The reference public key is used for uploading data.

By steps S2001 to S2021 shown in FIG. 20, initialization of the clients 2060-1 to 2060-3 and the server 2070 may be completed. Through this, the clients 2060-1 to 2060-3 in the group hold the same reference public key, and the server 2070 holds switching keys for the clients 2060-1 to 2060-3.

In the embodiment of FIG. 20, based on step S2019 to step S2021, the reference public key is determined by each of the clients 2060-1 to 2060-3. Based on another embodiment, one of the clients 2060-1 to 2060-3 may determine the reference public key and distribute it to other clients. For example, the first client 2060-1 may determine the reference public key and transmit information related to the reference public key to the other clients 2060-2, 2060-3. Accordingly, the second client 2060-2 and the third client 2060-3 may use the reference public key provided from the first client 2060-1.

As described above, when initialization for homomorphic encryption is performed, the clients' secret keys are not shared. Therefore, even if an attacker attacks the server, the secret keys are not exfiltrated, and high security may be ensured.

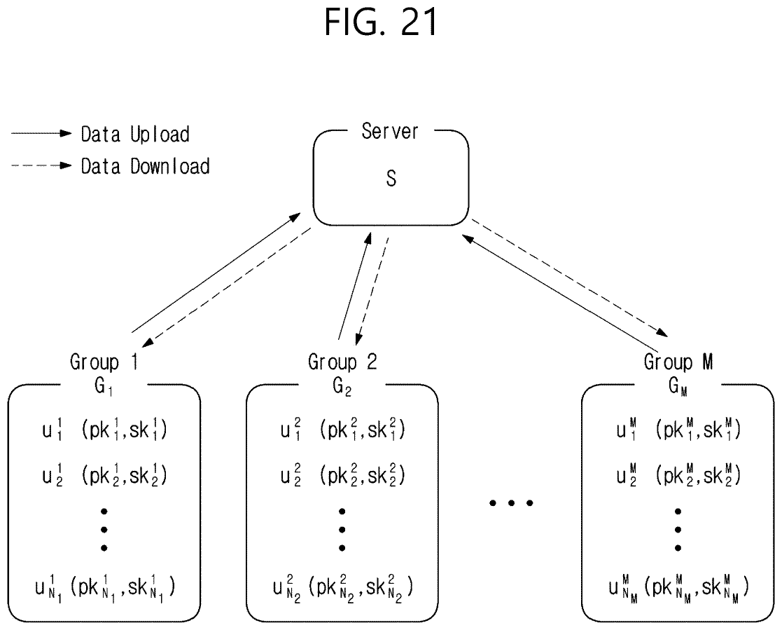

FIG. 21 shows an example of an initialized state for sharing data encrypted based on homomorphic encryption based on an embodiment of the present disclosure. In FIG. 21, M is the number of groups belonging to a cloud server S. The server S determines a switching key

$${Swk}_{S \to i}^{g}$$

required in a download process for data requested by a client for all i=1, 2, . . . , N_{g} based on the following [Equation 1].

$${Swk}_{S \to i}^{g} = {Enc}_{{pk}_{i}^{g}} ( {\sum }_{j = 1}^{{N}_{g}} s {k}_{j}^{g} ) \qquad [ Equation 1 ]$$

In [Equation 1],

$${Enc}_{{pk}_{i}^{g}} ( \cdot )$$

is a function that encrypts based on fully homomorphic encryption (FHE) with a public key of an i-th client, G_{g} is a g-th group (g=1, 2, . . . , M) including clients who want to share encrypted data,

$${Swk}_{S \to i}^{g}$$

is a switching key that may change data stored for an i-th client within a group G_{g} from a server S, N_{g} is the number of members of the group G_{g}, and

$${sk}_{j}^{g}$$

is the secret key of a j-th client within the group G_{g}.

Therefore, in order to generate a switching key on a server S, the server S receives all of

$${Enc}_{{pk}_{i}^{g}} ( {sk}_{j}^{g} )$$

from each client belonging to the group for i=1, 2, . . . , N_{g}, j=1, 2, . . . , N_{g}, and through a homomorphic addition operation, generates

$${Swk}_{S \to i}^{g} , i = 1 , 2 , ... , {N}_{g} .$$

Each client belonging to the group G_{g} generates and holds a secret key and public key pair

$$( {sk}_{i}^{g} , {pk}_{i}^{g} ) ,$$

and may determine a reference public key required in a data upload process based on the following [Equation 2].

$${Rpk}_{g} = {\sum }_{j = 1}^{{N}_{g}} {pk}_{j}^{g} \qquad [ Equation 2 ]$$

In [Equation 2], Rpk_{g} is a reference public key of G_{g}, and

$${pk}_{j}^{g}$$

denotes a public key of a j-th client of the group G_{g}.

Since the public keys of the clients

$${pk}_{j}^{g}$$

are public, each client generates a reference public key Rpk_{g} using the public keys that are public.

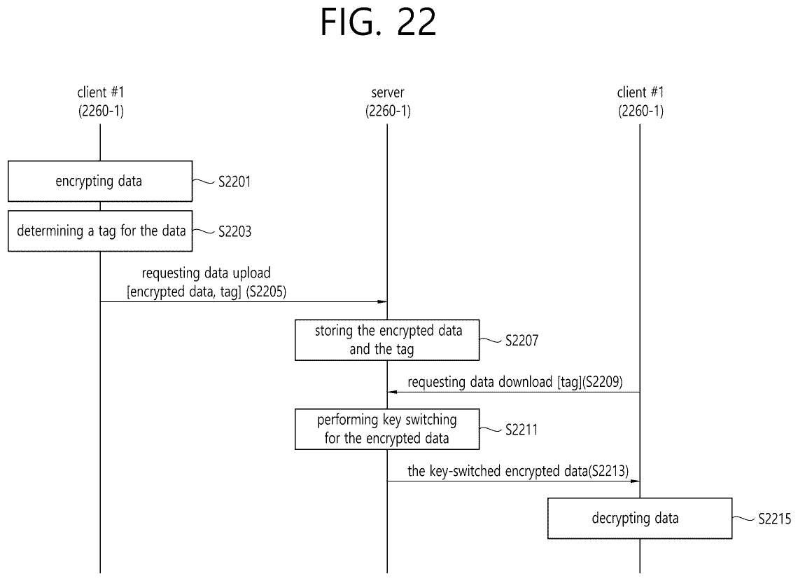

FIG. 22 shows an example of a procedure for uploading and downloading encrypted data based on homomorphic encryption based on an embodiment of the present disclosure. In FIG. 22, a first client 2260-1 and a second client 2260-2 belong to the same group and share data.

Referring to FIG. 22, in step S2201, the first client 2260-1 encrypts data. At this time, the data is encrypted by using the reference public key. The reference public key held by the first client 2260-1 is the reference public key of the group to which the first client 2260-1 belongs, and the data is data that the first client desires to share within the group to which the first client belongs.

In step S2203, the first client 2260-1 determines a tag for the data. The tag is identification information for the data encrypted with the reference public key and may be used to request the data from the server 2270. The tag may be determined based on a rule, and the rule may be predefined or instructed by the server 2270. That is, the first client 2260-1 may assign a tag to the data by using at least one input value based on the designated rule.

In step S2205, the first client 2260-1 transmits a request for data upload. In other words, the first client 2260-1 requests the server 2270 to store the encrypted data. To this end, the first client 2260-1 transmits the encrypted data and a tag for the data to the server 2270. Based on another embodiment, only the encrypted data may be transmitted without the tag. In this case, a method for determining the same tag in the server 2270 is required. For example, when a rule for determining the tag is shared between the first client 2260-1 and the server 2270, and the tag is determined based on an input value known to both the first client 2260-1 and the server 2270, transmission of the tag may be omitted.

In step S2207, the server 2270 stores the encrypted data and the tag. The server 2270 maps the encrypted data and the tag to each other and stores the encrypted data indexed by the tag. If the transmission of the tag is omitted in step S2205, the server 2270 generates the tag and stores the encrypted data and the tag.

In step S2209, the second client 2260-2 transmits a request for data download to the server 2270. To this end, the second client 2260-2 transmits a tag as identification information related to the data to be downloaded. In this embodiment, the second client 2260-2 transmits the tag generated in step S2203 to download the data encrypted in step S2201.

In step S2211, the server 2270 performs key switching for the encrypted data. The server 2270 confirms that the data encrypted in step S2201 is requested based on the tag received from the second client 2260-2 and transforms the encrypted data into a form decryptable by the second client 2260-2. Since the data encrypted with the reference public key may not be decrypted by the second client 2260-2, key switching is performed so that the data encrypted with the reference public key may be decrypted by using the secret key of the second client 2260-2. That is, the server 2270 performs key switching by using the switching key for the second client 2260-2.

In step S2213, the server 2270 transmits the key-switched encrypted data to the second client 2260-2. In other words, the server 2270 transmits the encrypted data, that is, the ciphertext, transformed to be decryptable by using the secret key of the second client 2260-2.

In step S2215, the second client 2260-2 decrypts the encrypted data by using the secret key of the second client 2260-2. Accordingly, the second client 2260-2 may acquire the original data.

Based on the embodiment as shown in FIG. 22, data may be shared without sharing secret keys of each client in the group. Accordingly, security may be enhanced. In addition, since the server performs homomorphic operations without decrypting the encrypted data, even if an attacker exfiltrates information of the clients through the server, the attacker may not identify the original data without the secret key, and thus robust security may be guaranteed.

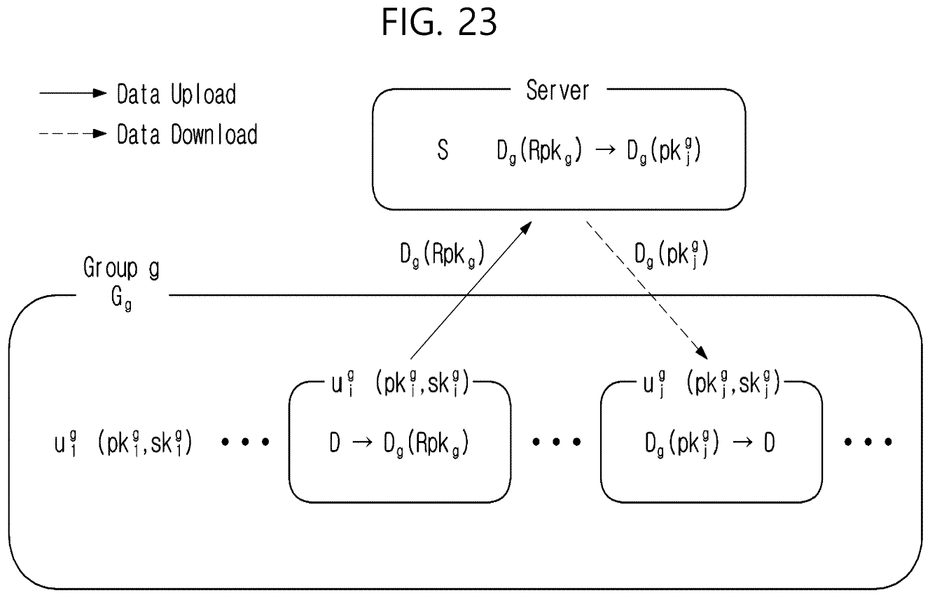

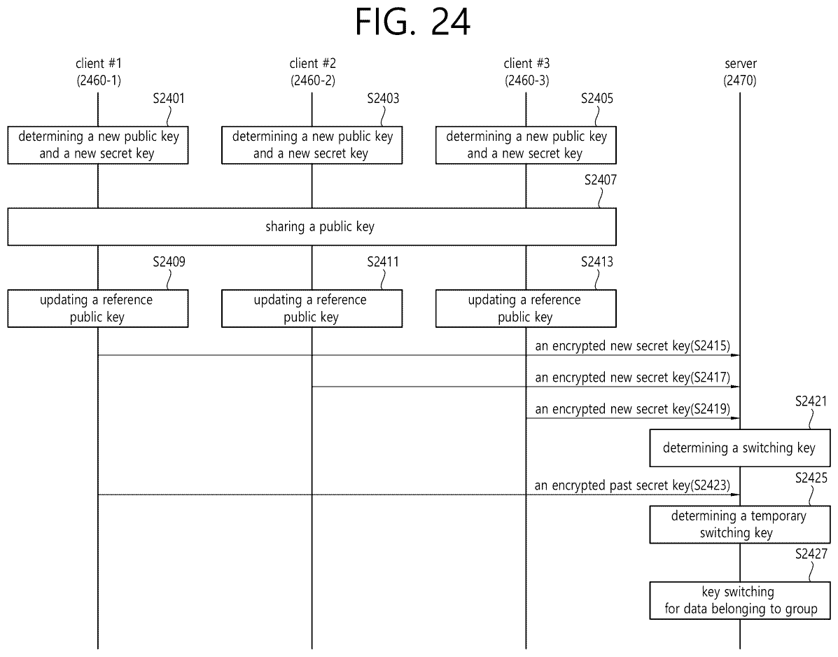

FIG. 23 shows an example of data transmitted for uploading and downloading data encrypted based on homomorphic encryption based on an embodiment of the present disclosure. Referring to FIG. 23, the i-th client

$${u}_{i}^{g}$$

of the group G_{g} may generate a ciphertext [symbol] _{g}(Rpk_{g}) as in the following [Equation 3].

$${𝒟}_{g} ( {Rpk}_{g} ) = {Enc}_{{Rpk}_{g}} ( 𝒟 ) \qquad [ Equation 3 ]$$

In [Equation 3], [symbol] is plaintext data to be encrypted, Rpk_{g} is a reference public key of the group G_{g}, and Enc_{A}(B) denotes a function that encrypts B based on fully homomorphic encryption with a reference public key A.

A client

$${u}_{i}^{g}$$

uploads the generated ciphertext [symbol] _{g}(Rpk_{g}) to a server S. At this time, since the data must be identifiable upon download, the client

$${u}_{i}^{g}$$

uploads a tag of the data to the server S along with the ciphertext. If a download of the encrypted data stored on the server S is desired, a client

$${u}_{j}^{g}$$

requests a download of the data [symbol] _{g}(Rpk_{g}) to the server. At this time, since the data stored on the server S is encrypted, the client

$${u}_{j}^{g}$$

indicates the data to be downloaded by using a tag capable of distinguishing the data. The server S may perform key switching as in the following [Equation 4] to enable the client

$${u}_{j}^{g}$$

to decrypt.

$${𝒟}_{g} ( {pk}_{j}^{g} ) = {Swk}_{S \to j}^{g} \{ {D}_{g} ( {Rpk}_{g} ) \} \qquad [ Equation 4 ]$$

In [Equation 4],

$${S w k}_{s \to j}^{g} \{ \cdot \}$$

is a key switching function, [symbol] _{g}(Rpk_{g}) is data encrypted with a reference public key of the group G_{g}, and

$${𝒟}_{g} ( {pk}_{j}^{g} )$$

denotes data encrypted with a public key of a j-th client within the group G_{g}.

The server S transmits the key-switched data

$${𝒟}_{g} ( {pk}_{j}^{g} )$$

to a client

$${u}_{j}^{g} .$$

A client

$${u}_{j}^{g}$$

obtains the original data [symbol] as in the following [Equation 5] by decrypting the received data

$${𝒟}_{g} ( {pk}_{j}^{g} )$$

using a secret key

$${sk}_{j}^{g} .$$

$$𝒟 = {Dec}_{s {k}_{j}^{g}} ( {𝒟}_{g} ( {pk}_{j}^{g} ) ) \qquad [ Equation 5 ]$$

In [Equation 5], [symbol] is plaintext data,

$${Dec}_{s {k}_{j}^{g}} ( \cdot )$$

is a function that decrypts a fully homomorphic-based ciphertext with a secret key

$${s k}_{j}^{g} , and {𝒟}_{g} ( {pk}_{j}^{g} )$$

denotes data encrypted with a public key of a j-th client within the group G_{g}.

FIG. 24 shows an example of a procedure for key refreshing to change a key for encryption based on homomorphic encryption based on an embodiment of the present disclosure. In FIG. 24, a first client to a third client 2460-1 to 2460-3 belong to the same group and share data. FIG. 20 shows a case where three clients 2460-1 to 2460-3 form one group, but the number of members included in one group may be two or less or four or more.

Referring to FIG. 24, in step S2401, step S2403, step S2405, each of the clients 2460-1 to 2460-3 determines a new public key and a secret key. To determine the public key and the secret key, the clients 2460-1 to 2460-3 use a predefined key generation rule, and based on the key generation rule, may update the public key and the secret key based on encryption parameters. For example, the encryption parameters may be determined based on an identifier of an entity (e.g., UE) including the clients 2460-1 to 2460-3. Based on another embodiment, the public key and the secret key may be determined by an entity other than the clients 2460-1 to 2460-3, and in this case, step S2401, step S2403, step S2405 may be understood as operations of checking the new public key and the secret key provided from the other entity.

In step S2407, the clients 2460-1 to 2460-3 share public keys. Since a reference public key for encryption based on homomorphic encryption is generated by using the public keys of the sharers, sharing of the public keys is required. Accordingly, each of the clients 2460-1 to 2460-3 transmits information related to the new public key (e.g., public key, encryption parameters, etc.) to other clients and receives information related to the new public keys of the other clients. Based on another embodiment, the public keys may be shared by another method, and in this case, step S2407 may be omitted.

In step S2409, step S2411, step S2413, each of the clients 2460-1 to 2460-3 updates the reference public key. In other words, each of the clients 2460-1 to 2460-3 determines a new reference public key. The reference public key is determined by adding all public keys of the members in the group. For example, the first client 2460-1 may determine the reference public key by adding the public key of the first client 2460-1, the public key of the second client 2460-2, the public key of the third client 2460-3.

In step S2415, step S2417, step S2419, each of the clients 2460-1 to 2460-3 transmits an encrypted secret key to the server 2470. Here, the secret key is encrypted by using the new public key of each of the clients 2460-1 to 2460-3 and then transmitted. For example, the first client 2460-1 may transmit control information or data including a secret key of the first client 2460-1 encrypted by using the new public key of the first client 2460-1, a secret key of the first client 2460-1 encrypted by using the new public key of the second client 2460-2, a secret key of the first client 2460-1 encrypted by using the new public key of the third client 2460-3. Similarly, the second client 2460-2 transmits control information or data including a secret key of the second client 2460-2 encrypted by using the new public key of each of the clients 2460-1 to 2460-3, and the third client 2460-3 may transmit control information or data including a secret key of the third client 2460-3 encrypted by using the new public key of each of the clients 2460-1 to 2460-3.

In step S2421, the server 2470 updates switching keys. In other words, the server 2470 determines new switching keys. The switching key is determined based on secret keys of all members in the group encrypted with the public key of the member that will decrypt the data. Accordingly, the server 2470 may determine switching keys for each of the clients 2460-1 to 2460-3 by performing a homomorphic addition operation on at least one of the encrypted new secret keys received in step S2415, step S2417, step S2419. For example, the server 2240 may determine a new switching key for the first client 2460-1 by homomorphically adding the new secret key of the first client 2460-1 encrypted with the new public key of the first client 2460-1, the new secret key of the second client 2220 encrypted with the new public key of the first client 2460-1, and the new secret key of the third client 2460-3 encrypted with the new public key of the first client 2460-1.

By steps S2401 to S2421, the keys may be updated. Accordingly, the clients 2460-1 to 2460-3 may upload data by using the new reference public key, and the server 2470 may provide data by using the new switching keys. However, since the data stored before the update of the keys is encrypted by using the past reference public key, it is still processed by using the past switching keys and may be decrypted by using the past secret keys. In this case, protection of the data stored in the past may be insufficient, and therefore, it is desirable to process such that the new keys may also be applied to the past data. To this end, the following steps may be performed.

In step S2423, the first client 2460-1 transmits an encrypted past secret key to the server 2470. The encrypted past secret key is obtained by encrypting the secret key of the first client 2460-1 before the update of the keys by using the new reference public key and then transmitted. That is, the first client 2460-1 transmits information related to the past secret key encrypted by using the new reference public key.

In step S2425, the server 2470 determines a temporary switching key. The temporary switching key is a key used to change the data stored before the update of the keys so as to be decryptable by using the new switching keys. The server 2470 may determine the temporary switching key by performing key switching on the past switching key for the first client 2110 by using the past secret key encrypted with the new reference public key, which was received in step S2423, as a switching key.

In step S2427, the server 2470 performs key switching for the data belonging to the group. That is, the server 2470 performs data key switching. Specifically, the server 2470 may perform key switching on the data stored before the update of the keys by using the temporary switching key. As a result, the data stored before the update of the keys is changed into data encrypted by using the current reference public key.

The key refreshing described with reference to FIG. 24 may be performed for enhancing security. For example, when leakage of a key is suspected, a key is corrupted, or a session is terminated, the key refreshing procedure may be performed. Alternatively, security of data may be enhanced through periodic key refreshing. At this time, as described above, since re-encryption of the data stored in the server may be performed by the cloud server itself, it is not required that the client re-encrypt the encrypted data and upload it again. As a result, waste of resources may be reduced. In addition, based on the characteristics of homomorphic encryption, since the secret key is not transmitted to the server, high security may be ensured.

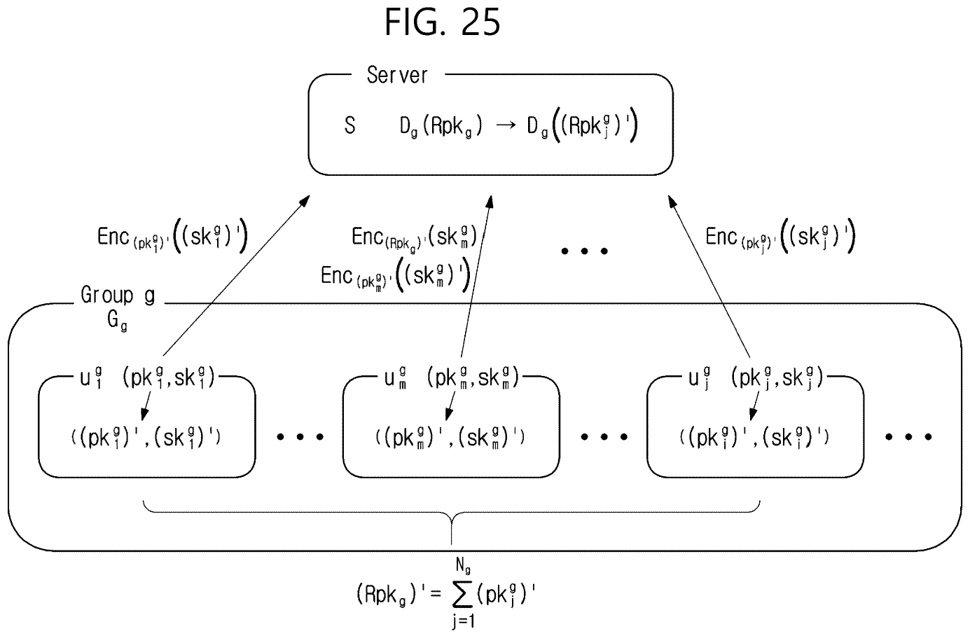

FIG. 25 shows an example of data transmitted for key refreshing, which changes a key for encryption based on homomorphic encryption based on an embodiment of the present disclosure. First, a reference public key is updated. Specifically, each client

$${u}_{i}^{g} ( i = 1 , 2 , ... , {N}_{g} )$$

obtains a new secret key and public key pair

$$( {( s {k}_{i}^{g} )}^{′} , {( {pk}_{i}^{g} )}^{′} )$$

by newly generating a secret key and public key pair for each client. The reference public key may be updated by using the new public keys of the clients as shown in [Equation 6] below.

$${( {Rpk}_{g} )}^{′} = {\sum }_{j = 1}^{{N}_{g}} {( {pk}_{j}^{g} )}^{′} \qquad [ Equation 6 ]$$

In [Equation 6], (Rpk_{g})′ is the updated reference public key, and

$${pk}_{j}^{g}$$

denotes a public key of a j-th client of the group G_{g}.

Next, a switching key is updated. Specifically, each client

$${u}_{i}^{g} ( i = 1 , 2 , ... , {N}_{g} )$$

encrypts a new secret key of each client by using new public keys of clients in the same group, and transmits it to a server. The secret key may be encrypted as in the following [Equation 7].

$${Enc}_{{( {pk}_{j}^{g} )}^{′}} ( {( {sk}_{i}^{g} )}^{′} ) \qquad [ Equation 7 ]$$

In [Equation 7],

$${Enc}_{{( {pk}_{j}^{g} )}^{′}} ( \cdot )$$

is a function that encrypts using a public key of a j-th client, and

$${( {sk}_{i}^{g} )}^{′}$$

denotes a new secret key of an i-th client of the group G_{g}.

The server S may update a switching key using the received

$${Enc}_{{( {pk}_{j}^{g} )}^{′}} ( {( {sk}_{i}^{g} )}^{′} ) ( i = 1 , 2 , … , {N}_{g} , j = 1 , 2 , … , {N}_{g} ) .$$

The switching key may be updated through a homomorphic addition operation as in the following [Equation 8].

$${( {Swk}_{S \to i}^{g} )}^{′} = {\sum }_{j = 1}^{{N}_{g}} {Enc}_{{( {pk}_{i}^{g} )}^{′}} ( {( {sk}_{j}^{g} )}^{′} ) \qquad [ Equation 8 ]$$

In [Equation 8],

$${( {Swk}_{S \to i}^{g} )}^{′}$$

is a new switching key for an i-th client within the group G_{g} from a server,

$${Enc}_{{( {pk}_{i}^{g} )}^{′}} ( \cdot )$$

is a function that encrypts using a new public key of the i-th client, and

$${( {sk}_{j}^{g} )}^{′}$$

denotes a new secret key of a j-th client of the group G_{g}.

Subsequently, a data key is updated. Specifically, in order to perform key switching for the data of the group G_{g} stored on a server, a representative client

$${u}_{m}^{g}$$

among the clients transmits an encrypted old secret key

$${( TSwk )}^{′} = {Enc}_{{( {Rpk}_{g} )}^{′}} ( {sk}_{m}^{g} )$$

to the server using a new reference public key. The server, using a switching key

$${Swk}_{S \to m}^{g} = {Enc}_{{pk}_{m}^{g}} ( {\sum }_{j = 1}^{{N}_{g}} {sk}_{j}^{g} )$$

that was previously stored and the received (TSwk)′ from the client

$${u}_{m}^{g} ,$$

may determine a temporary switching key as in the following [Equation 9].

$$TSwk = {( TSwk )}^{′} \{ {Swk}_{S \to m}^{g} \} = {( TSwk )}^{′} \{ {Enc}_{{pk}_{m}^{g}} ( {\sum }_{j = 1}^{{N}_{g}} {sk}_{j}^{g} ) \} = {Enc}_{{( {Rpk}_{g} )}^{′}} ( {\sum }_{j = 1}^{{N}_{g}} {sk}_{j}^{g} ) \qquad [ Equation 9 ]$$

In [Equation 9], TSwk is a temporary switching key, (TSwk)′ is a past secret key of a representative client encrypted using a new reference public key,

$${Swk}_{S \to m}^{g}$$

is a switching key for an m-th client within the group G_{g} from a server,

$${Enc}_{{( {pk}_{m}^{g} )}^{′}} ( \cdot )$$

is a function that encrypts based on fully homomorphic encryption with a public key of the m-th client, (Rpk_{g})′ is a new reference public key of the group G_{g}, and

$${sk}_{j}^{g}$$

denotes a secret key of a j-th client within the group G_{g} from a server.

The server, using the obtained temporary switching key TSwk, may perform key switching for the data of the group G_{g} stored on the server as in the following [Equation 10].

$${𝒟}_{g} ( {( {Rpk}_{g} )}^{′} ) = TSwk \{ {𝒟}_{g} ( {Rpk}_{g} ) \} \qquad [ Equation 10 ]$$

In [Equation 10], [symbol] _{g}(Rpk_{g}) is data encrypted using a past reference public key of the group G_{g}, and [symbol] _{g}((Rpk_{g})′) denotes data encrypted using a new reference public key of the group G_{g}.

Accordingly, data stored with the past reference public key is changed to data encrypted using the new reference public key.

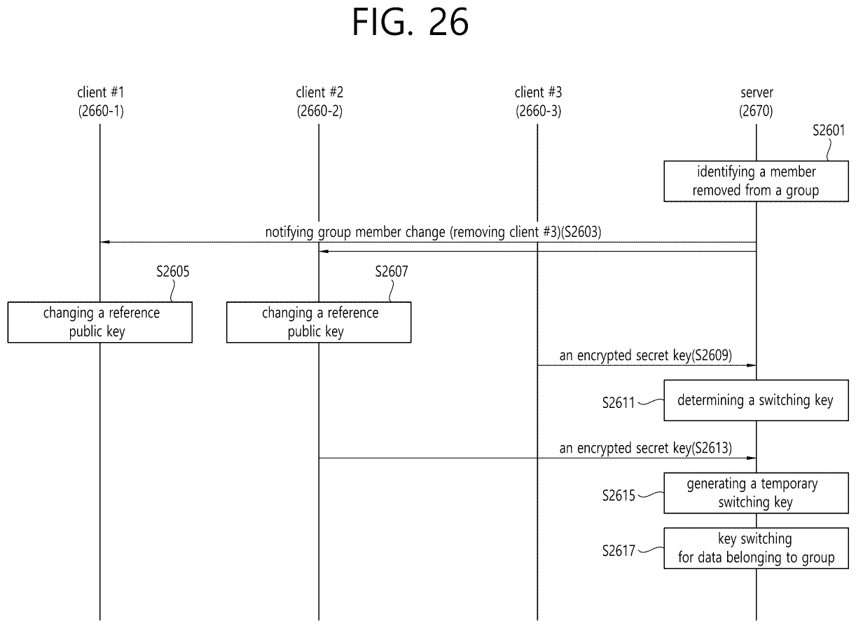

FIG. 26 shows an example of a procedure for removing a member from a group sharing data based on homomorphic encryption based on an embodiment of the present disclosure. In FIG. 26, a first client to a third client 2660-1 to 2660-3 belong to the same group and share data. FIG. 26 shows a case where three clients 2660-1 to 2660-3 form one group, but the number of clients included in one group may be two or less or four or more.

Referring to FIG. 26, in step S2601, the server 2670 identifies a member to be removed from the group. In this embodiment, the third client 2660-3 is removed, and the server 2670 determines to remove the third client 2660-3 from the group. For example, the server 2670 may determine to remove the third client 2660-3 by recognizing withdrawal from a communication service such as session termination or disconnection of the third client 2660-3, by receiving a group removal request from the third client 2660-3, or by checking expiration of an access permission period of the third client 2660-3.

In step S2603, the server 2670 transmits a notification of the change of the group member to the first client 2660-1 and the second client 2660-2. The notification instructs removal of the third client 2660-3. That is, the server 2670 notifies the remaining members in the group, in other words, the first client 2660-1 and the second client 2660-2, of the addition of the third client 2660-3.

In step S2605, step S2607, each of the first client 2660-1 and the second client 2660-2 updates the reference public key. In other words, each of the first client 2660-1 and the second client 2660-2 determines a new reference public key. The reference public key is determined by adding all public keys of the members in the group. Since the third client 2660-3 is removed from the group, the past reference public key based on the public key of the third client 2660-3 is no longer valid. Accordingly, each of the first client 2660-1 and the second client 2660-2 may generate a new reference public key based on the public key of the first client 2660-1 and the public key of the second client 2660-2. For example, the first client 2660-1 may determine the new reference public key by subtracting the public key of the third client 2660-3 from the past reference public key.

In step S2609, the third client 2660-3 transmits a secret key encrypted by using public keys of other members to the server 2670. Here, the secret key is encrypted by using the public key of each of the clients 2660-1 to 2660-3 and then transmitted. For example, the third client 2660-3 may transmit control information or data including a secret key of the third client 2660-3 encrypted by using the public key of the first client 2660-1, a secret key of the third client 2660-3 encrypted by using the public key of the second client 2660-2. However, if the secret key of the third client 2660-3 encrypted and provided during the initialization procedure or the key refreshing procedure is stored in the server 2670, this step may be omitted.

In step S2611, the server 2670 updates switching keys. In other words, the server 2670 determines new switching keys. The switching key is determined based on secret keys of all members in the group encrypted with the public key of the member that will decrypt the data. Since the third client 2660-3 is removed from the group, the past switching keys based on the secret key of the third client 2660-3 are no longer valid. Accordingly, the server 2670 may generate new switching keys based on the secret key of the first client 2660-1 and the secret key of the second client 2660-2. For example, the server 2670 may generate a new switching key for the first client 2660-1 by subtracting the secret key of the third client 2660-3 encrypted by using the public key of the first client 2310 from the past switching key for the first client 2660-1.

By steps S2601 to S2611, a member may be removed from the group. Accordingly, the clients 2660-1 and 2660-2 may upload data by using the new reference public key determined based on the change of the member, and the server 2670 may provide data by using the new switching keys. However, since the data stored before the removal of the member is encrypted by using the past reference public key, it is still processed by using the past switching keys and may be decrypted by using the past secret keys. In this case, protection of the data stored in the past may be insufficient, and therefore, it is desirable to process such that the new keys may also be applied to the past data. To this end, the following steps may be performed.

In step S2613, the first client 2660-1 transmits an encrypted secret key to the server 2670. Here, the secret key is obtained by encrypting the secret key of the first client 2461-1 with the new reference public key and then transmitted. That is, the first client 2660-1 transmits information related to the secret key encrypted by using the new reference public key within the group.

In step S2615, the server 2670 determines a temporary switching key. The temporary switching key is a key used to change the data stored before the update of the keys so as to be decryptable by using the new switching keys. The server 2670 may determine the temporary switching key by performing key switching on the past switching key for the first client 2110 by using the past secret key encrypted with the new reference public key, which was received in step S2613, as a switching key.

In step S2617, the server 2670 performs key switching for the data belonging to the group. That is, the server 2670 performs data key switching. Specifically, the server 2670 may perform key switching on the data stored before the update of the keys by using the temporary switching key. As a result, the data stored before the update of the keys is changed into data encrypted by using the current reference public key.

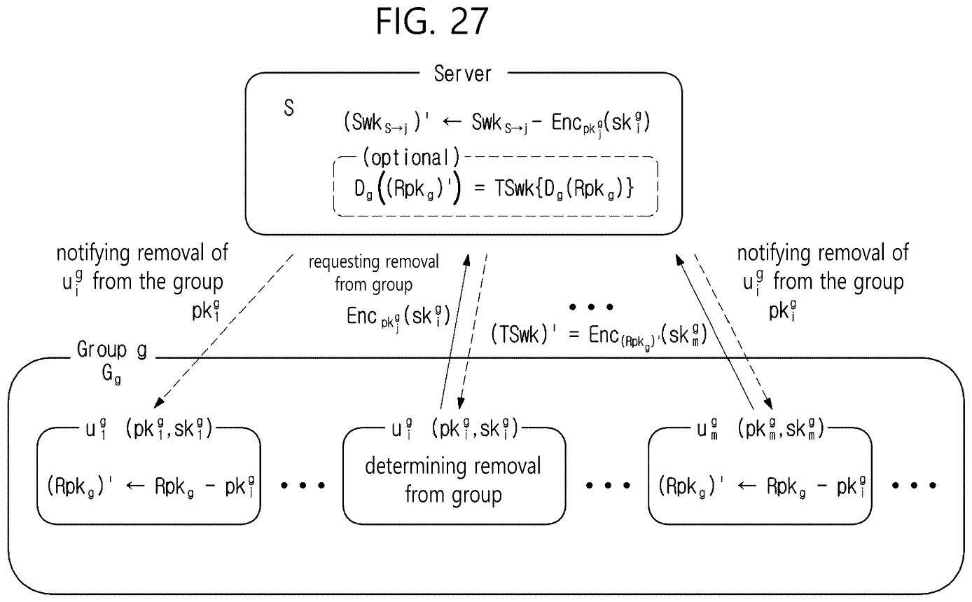

FIG. 27 shows an example of data delivered for removing a member from a group sharing data based on homomorphic encryption based on an embodiment of the present disclosure. Referring to FIG. 27, a situation in which client

$${u}_{i}^{g}$$

is removed from group G_{g} is shown.

First, the reference public key is updated. Specifically,

$${u}_{j}^{g} ( j = 1 , … , {N}_{g} , j \neq 1 )$$

excluding the client

$${u}_{i}^{g}$$

may update the reference public key as in the following [Equation 11]. At the time, since

$${pk}_{i}^{g}$$

is a public key of

$${u}_{i}^{g} ,$$

access is possible by the remaining members.

$${( {Rpk}_{g} )}^{′} = {Rpk}_{g} - {pk}_{i}^{g} \qquad [ Equation 11 ]$$

In [Equation 11], Rpk_{g} is a reference public key of the group G_{g},

$${pk}_{i}^{g}$$

is a public key of an i-th client of the group G_{g}, and (Rpk_{g})′ denotes a new reference public key.

And, a switching key is updated. The server S updates the switching key as in the following [Equation 12].

$${( {Swk}_{S \to j}^{g} )}^{′} = {Swk}_{S \to j}^{g} - {Enc}_{{pk}_{j}^{g}} ( {sk}_{i}^{g} ) \qquad [ Equation 12 ]$$

In [Equation 12],

$${Enc}_{{pk}_{j}^{g}} ( \cdot )$$

is a function that encrypts with a public key of a j-th client,

$${sk}_{j}^{g}$$

is a secret key of an j-th client within the group G_{g},

$${Swk}_{S \to j}^{g}$$

is a switching key that may change data stored for an j-th client within the group G_{g} from a server, and

$${( {Swk}_{S \to j}^{g} )}^{′}$$

denotes a new switching key that changes

$${Swk}_{S \to j}^{g} .$$

In order to update the switching key on a server, a client

$${u}_{i}^{g}$$

encrypts its own secret key

$$s {k}_{i}^{g}$$

using the public keys of other clients

$${u}_{j}^{g} ,$$

and then may transmit it to the server.

Subsequently, data management is performed. Data stored by a client

$${u}_{i}^{g}$$

on a server S may be deleted or may be kept as is. In addition, key switching for group data stored in the group G_{g} may be performed, or it may be kept without key switching. If it is kept without key switching, the server may maintain the original switching key

$$S w {k}_{S \to j}^{g} ( j = 1 , 2 , ⋯ , {N}_{g} , j \neq i , ) .$$

When key switching for group data stored in the group G_{g} is performed, data key switching is performed as follows.

A representative client

$${u}_{m}^{g}$$

transmits an encrypted past secret key

$${( TSwk )}^{′} = {Enc}_{{( {Rpk}_{g} )}^{′}} ( {sk}_{m}^{g} )$$

to the server using a new reference public key. The server, using the received (TSwk)′, may generate a temporary switching key TSwk as in the following [Equation 13].

$$\begin{matrix}TSwk = {( TSwk )}^{′} \{ {Swk}_{S \to m}^{g} \} \\ = {( TSwk )}^{′} \{ {Enc}_{p {k}_{m}^{g}} ( {\sum }_{j = 1}^{{N}_{g}} {sk}_{j}^{g} ) \} \\ = {Enc}_{{( {Rpk}_{g} )}^{′}} ( {\sum }_{j = 1}^{{N}_{g}} {sk}_{j}^{g} )\end{matrix} \qquad [ Equation 13 ]$$

In [Equation 13], TSwk is a temporary switching key, (TSwk)′ is a past secret key of is a switching key a representative client encrypted using a new reference public key,

$${Swk}_{S \to m}^{g}$$

is a switching key for an m-th client within the group G_{g} from a server,

$$E n {c}_{p {k}_{m}^{g}} ( \cdot )$$

is a function that encrypts based on fully homomorphic encryption with a public key of the m-th client, (Rpk_{g})′ is a new reference public key of the group G_{g}, and

$$s {k}_{j}^{g}$$

denotes a secret key of a j-th client within the group G_{g} from a server.

The server, using the obtained temporary switching key TSwk, may perform key switching for the data of the group G_{g} stored on the server as in the following [Equation 14]. Key switching may be performed as in the following [Equation 14].

$${𝒟}_{g} ( {( R p {k}_{g} )}^{′} ) = T Swk \{ {𝒟}_{g} ( {Rpk}_{g} ) \} \qquad [ Equation 14 ]$$

In [Equation 14], [symbol] _{g}(Rpk_{g}) is data encrypted using a past reference public key of the group G_{g}, and [symbol] _{g}((Rpk_{g})′) is data encrypted using a new reference public key of the group G_{g}

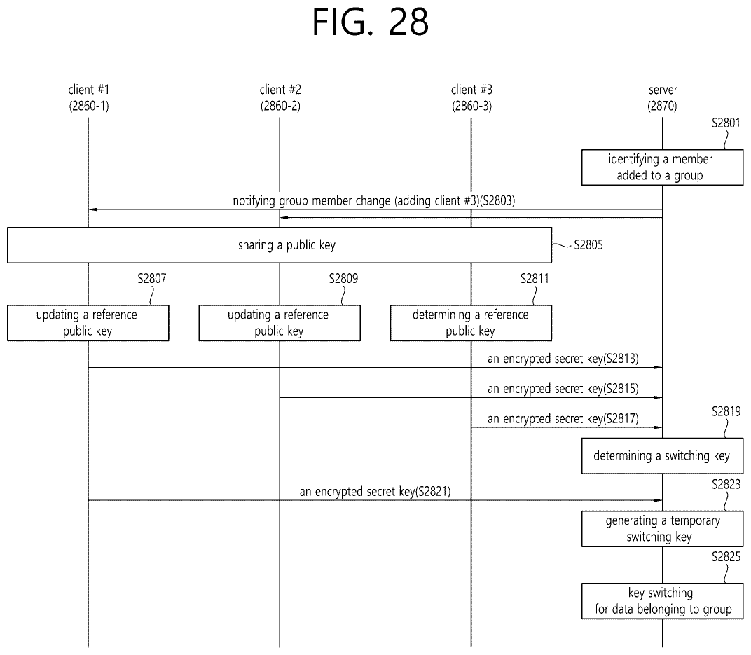

FIG. 28 shows an example of a procedure for adding a member to a group sharing data based on homomorphic encryption based on an embodiment of the present disclosure. In FIG. 28, a first client to a third client 2860-1 to 2860-3 belong to the same group and share data. FIG. 28 shows a case where three clients 2860-1 to 2860-3 form one group, but the number of clients included in one group may be two or less or four or more.

Referring to FIG. 28, in step S2801, the server 2870 identifies a member to be added to the group. In this embodiment, the third client 2860-3 is added, and the server 2870 determines to add the third client 2860-3 to the group. For example, the server 2870 may determine to add the third client 2860-3 by recognizing participation of the third client 2860-3 in the sharing service or by receiving a group participation request from the third client 2860-3.

In step S2803, the server 2870 transmits a notification of the change of the group member to the first client 2860-1 and the second client 2860-2. The notification instructs addition of the third client 2860-3. That is, the server 2870 notifies the remaining members in the group, in other words, the first client 2860-1 and the second client 2860-2, of the addition of the third client 2860-3.

In step S2805, the clients 2860-1 to 2860-3 share public keys. Since a reference public key for encryption based on homomorphic encryption is generated by using the public keys of the sharers, sharing of the public keys is required. Accordingly, each of the clients 2860-1 to 2860-3 transmits information related to the new public key (e.g., public key, encryption parameters, etc.) to other clients and receives information related to the new public keys of the other clients. At this time, since the first client 2860-1 and the second client 2860-2 have already shared public keys through the initialization procedure or the key refreshing procedure, the public key sharing operation between the first client 2860-1 and the second client 2860-2 may be omitted. Based on another embodiment, the public keys may be shared by another method, and in this case, step S2805 may be omitted.

In step S2807, step S2809, each of the first client 2860-1 and the second client 2860-2 updates the reference public key. In other words, each of the first client 2860-1 and the second client 2860-2 determines a new reference public key. The reference public key is determined by adding all public keys of the members in the group. Since the third client 2860-3 is added to the group, the past reference public key not based on the public key of the third client 2860-3 is no longer valid. Accordingly, each of the first client 2860-1 and the second client 2860-2 may generate a new reference public key based on the public key of the first client 2860-1, the public key of the second client 2860-2, the public key of the third client 2860-3. For example, the first client 2860-1 may determine the new reference public key by adding the public key of the third client 2860-3 to the past reference public key.

In step S2811, the third client 2860-3 determines the reference public key. The third client 2860-3 may generate the reference public key based on the public key of the first client 2860-1, the public key of the second client 2860-2, the public key of the third client 2860-3. The generated reference public key will be the same as the reference public key updated in step S2807 or step S2809. Based on another embodiment, this step may be replaced with an operation in which the first client 2860-1 or the second client 2860-2 shares the reference public key with the third client 2860-3.

In step S2813, step S2815, step S2817, each of the clients 2860-1 to 2860-3 transmits an encrypted secret key to the server 2870. Here, the secret key is encrypted by using the public key of each of the clients 2860-1 to 2860-3 and then transmitted. However, if the secret keys of the first client 2860-1 and the second client 2860-2 encrypted by using the public key of the first client 2860-1 and the public key of the second client 2860-2, which were provided during the initialization procedure or the key refreshing procedure, are stored in the server 2870, the first client 2860-1 and the second client 2860-2 may transmit only the secret keys encrypted by using the public key of the third client 2860-3.

In step S2819, the server 2870 determines switching keys. In other words, the server 2870 updates the switching keys for the first client 2860-1 and the second client 2860-2, and generates a switching key for the third client 2860-3. The switching key is determined based on secret keys of all members in the group encrypted with the public key of the member that will decrypt the data. Since the third client 2860-3 is added to the group, the past switching keys not based on the secret key of the third client 2860-3 are no longer valid. Accordingly, the server 2870 may generate new switching keys based on the secret keys of the clients 2860-1 to 2860-3. For example, the server 2870 may generate a new switching key for the first client 2860-1 by adding the secret key of the third client 2860-3, which is encrypted by using the public key of the first client 2310, to the past switching key for the first client 2860-1.

By steps S2801 to S2819, a member may be added to the group. Accordingly, the clients 2860-1 to 2860-3 may upload data by using the new reference public key determined based on the change of the member, and the server 2870 may provide data by using the new switching keys. However, since the data stored before the addition of the member is encrypted by using the past reference public key, it is still processed by using the past switching keys and may be decrypted by using the past secret keys. In this case, the third client 2860-3 may not access the data stored in the past, and therefore, it is desirable to process such that the new keys may also be applied to the past data. To this end, the following steps may be performed.

In step S2821, the first client 2860-1 transmits an encrypted secret key to the server 2870. Here, the secret key is obtained by encrypting the secret key of the first client 2860-1 with the new reference public key and then transmitted. That is, the first client 2860-1 transmits information related to the secret key encrypted by using the new reference public key.

In step S2823, the server 2870 determines a temporary switching key. The temporary switching key is a key used to change the data stored before the update of the keys so as to be decryptable by using the new switching keys. The server 2870 may determine the temporary switching key by performing key switching on the past switching key for the first client 2860-1 by using the past secret key encrypted with the new reference public key, which was received in step S2821, as a switching key.

In step S2825, the server 2870 performs key switching for the data belonging to the group. That is, the server 2870 performs data key switching. Specifically, the server 2870 may perform key switching on the data stored before the update of the keys by using the temporary switching key. As a result, the data stored before the update of the keys is changed into data encrypted by using the current reference public key.

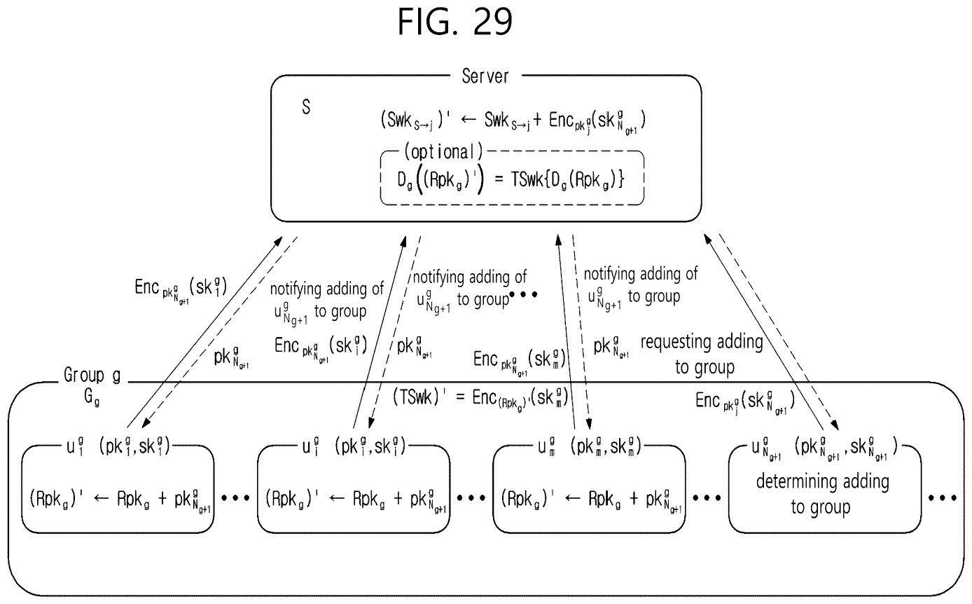

FIG. 29 shows an example of data delivered for adding a member to a group sharing data based on homomorphic encryption based on an embodiment of the present disclosure. Referring to FIG. 29, a situation in which client

$${u}_{{N}_{g + 1}}^{g}$$

is added to group G_{g} is shown.

First, a reference public key is updated. Specifically, when a client

$${u}_{{N}_{g + 1}}^{g}$$

participating in the group is determined, the reference public keys of the existing clients

$${u}_{i}^{g} ( i = 1 , 2 , ⋯ , {N}_{g} )$$

belonging to the group G_{g} may be updated as in the following [Equation 15].

$${( {Rpk}_{g} )}^{′} = {Rpk}_{g} + p {k}_{{N}_{g + 1}}^{g} \qquad [ Equation 15 ]$$

In [Equation 15],

$$p {k}_{{N}_{g + 1}}^{g}$$

is a public key of a client

$${u}_{{N}_{g + 1}}^{g} ,$$

and (Rpk_{g})′ denotes a new reference public key that is updated as

$${u}_{{N}_{g + 1}}^{g}$$

is added.

In addition, a newly added client

$${u}_{{N}_{g + 1}}^{g}$$

receives an existing reference public key from a representative client

$${u}_{m}^{g}$$

belonging to the group G_{g} or receives all of the public keys of the clients of the group, and the new reference public key may be generated as in the following [Equation 16].

$${( {Rpk}_{g} )}^{′} = {\sum }_{j = 1}^{{N}_{g + 1}} p {k}_{j}^{g} \qquad [ Equation 16 ]$$

In [Equation 16], (Rpk_{g})′ is a reference public key after

$${u}_{{N}_{g + 1}}^{g}$$

has participated, and

$$p {k}_{j}^{g}$$

denotes a public key of a j-th client within the group G_{g}.

Subsequently, a switching key is updated. Specifically, the server S receives

$$E n {c}_{p {k}_{j}^{g}} ( s {k}_{{N}_{g + 1}}^{g} ) ( j = 1 , 2 , ⋯ , {N}_{g} )$$

from the client

$${u}_{{N}_{g + 1}}^{g} ,$$

and the switching key for the group G_{g} may be updated as in the following [Equation 17].

$${( S w {k}_{S \to j}^{g} )}^{′} = {Swk}_{S \to j}^{g} + E n {c}_{p {k}_{j}^{g}} ( s {k}_{{N}_{g + 1}}^{g} ) \qquad [ Equation 17 ]$$

In [Equation 17],

$$E n {c}_{p {k}_{j}^{g}} ( \cdot )$$

is a function that encrypts using a public key of a j-th client,

$$s {k}_{{N}_{g + 1}}^{g}$$

is a secret key of an N_{g+1}-th client within the group G_{g},

$$S w {k}_{S \to j}^{g}$$

is a switching key that may change data stored for a j-th client within the group G_{g} from a server, and

$${( {Swk}_{S \to j}^{g} )}^{′}$$

denotes a new switching key that has changed

$${Swk}_{S \to j}^{g} .$$

In addition, in order to change a switching key for a client

$${u}_{{N}_{g + 1}}^{g}$$

a server receives

$$E n {c}_{p {k}_{N g + 1}^{g}} ( s {k}_{i}^{g} )$$

from each client

$${u}_{i}^{g} ( i = 1 , 2 , … , {N}_{g + 1} ) ,$$

and using a homomorphic addition operation, may determine a switching key

$${( {Swk}_{S \to {N}_{g + 1}}^{g} )}^{′}$$

as in the following [Equation 18].

$${( {Swk}_{S \to {N}_{g} + 1}^{g} )}^{′} = {Enc}_{p {k}_{{N}_{g} + 1}^{g}} ( {\sum }_{j = 1}^{{N}_{g} + 1} s {k}_{j}^{g} ) \qquad [ Equation 18 ]$$

In [Equation 18],

$$E n {c}_{p {k}_{{N}_{g} + 1}^{g}} ( \cdot )$$

is a function that encrypts with a public key of an N_{g}+1-th client,

$$s {k}_{j}^{g}$$

is a secret key of a j-th client within the group G_{g},

$${Swk}_{S \to {N}_{g} + 1}^{g}$$

is a switching key that may change data stored for an N_{g}+1-th client within the group G_{g} from a server, and

$${( {Swk}_{S \to {N}_{g} + 1}^{g} )}^{′}$$

denotes a new switching key that has changed

$${Swk}_{S \to {N}_{g} + 1}^{g} .$$

And, data management is performed. The server may perform key switching for the group data stored in group G_{g} or may store the data without key switching. If the data is stored without key switching, the server may maintain the original switching key

$${Swk}_{s \to j}^{g} ( i = 1 , 2 , … , {N}_{g} ) .$$

In addition, the server may generate and store a switching key for access of client

$${u}_{{N}_{g} + 1}^{g}$$

to the existing data as shown in [Equation 19] below.

$${Swk}_{S \to {N}_{g} + 1}^{g} = {Enc}_{p {k}_{{N}_{g} + 1}^{g}} ( {\sum }_{j = 1}^{{N}_{g}} s {k}_{j}^{g} ) \qquad [ Equation 19 ]$$

In [Equation 19],

$$E n {c}_{p {k}_{{N}_{g} + 1}^{g}} ( \cdot )$$

is a function that encrypts using a public key of an N_{g}+1-th client

$$s {k}_{{N}_{g + 1}}^{g}$$

is a secret key of an N_{g+1}-th client within the group G_{g},

$$S w {k}_{S \to {N}_{g} + 1}^{g}$$

is a switching key that may change data stored for an N_{g}+1-th client within the group G_{g} from a server, and

$${( S w {k}_{S \to {N}_{g} + 1}^{g} )}^{′}$$

denotes a new switching key that has changed

$$S w {k}_{S \to {N}_{g} + 1}^{g} .$$

When performing key switching for group data stored in the group G_{g}, a server and a representative client perform data key switching as follows. A representative client

$${u}_{m}^{g}$$

of the group G_{g} generates

$${( TSwk )}^{′} = {Enc}_{( {Rpk}_{g} )} ( {sk}_{m}^{g} )$$

and transmits it to the server. The server, using the received (TSwk)′, generates a temporary switching key as in the following [Equation 20].

$$TSwk = {( TSwk )}^{′} \{ {Swk}_{S \to m}^{g} \} = {( TSwk )}^{′} \{ En {c}_{p {k}_{m}^{g}} ( {\sum }_{j = 1}^{{N}_{g}} s {k}_{j}^{g} ) \} = E n {c}_{{( R p {k}_{g} )}^{′}} ( {\sum }_{j = 1}^{{N}_{g}} s {k}_{j}^{g} ) \qquad [ Equation 20 ]$$

In [Equation 20], TSwk is a temporary switching key, (TSwk)′ is a past secret key of a representative client encrypted using a new reference public key,

$$S w {k}_{S \to m}^{g}$$

is a switching key for an m-th client within the group G_{g} from a server,

$$E n {c}_{p {k}_{m}^{g}} ( \cdot )$$

is a function that encrypts based on fully homomorphic encryption with a public key of the m-th client, (Rpk_{g})′ is a new reference public key of the group G_{g}, and

$$s {k}_{j}^{g}$$

denotes a secret key of a j-th client within the group G_{g} from a server.

The server, using the temporary switching key TSwk, performs key switching for the group G_{g} data stored on the server. Key switching may be performed as in the following [Equation 21].

$${𝒟}_{g} ( {( R p {k}_{g} )}^{′} ) = T Swk \{ {𝒟}_{g} ( R p {k}_{g} ) \} \qquad [ Equation 21 ]$$

In [Equation 21], [symbol] _{g}(Rpk_{g}) is data encrypted using a past reference public key of the group G_{g}, and [symbol] _{g}((Rpk_{g})′) denotes data encrypted using a new reference public key of the group G_{g}.

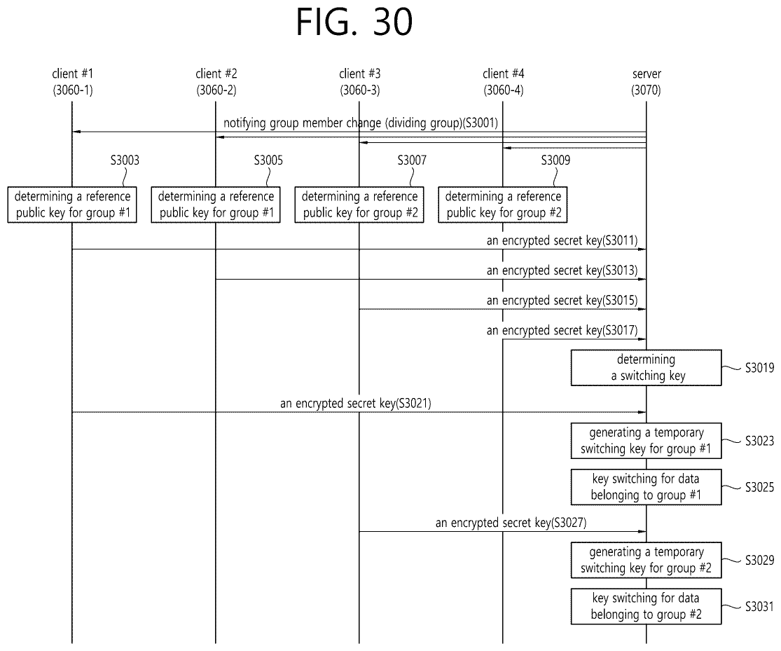

FIG. 30 shows an example of a procedure for dividing a group sharing data based on homomorphic encryption based on an embodiment of the present disclosure. In FIG. 30, a first client to a fourth client 3060-1 to 3060-4 belong to the same group and are divided into two groups by the procedure described below. FIG. 30 shows a case where four clients 3060-1 to 3060-4 form one group, but the number of clients included in one group may be three or less or five or more. For convenience of description, the groups after division are referred to as Group #1 and Group #2.

Referring to FIG. 30, in step S3001, the server 3070 transmits a notification of the change of the group members to the members belonging to the group. Here, the notification instructs that the group is divided into Group #1 and Group #2. That is, the server 3070 instructs the first client to the fourth client 3060-1 to 3060-4 of the division of the group, and notifies that the first client 3060-1 and the second client 3060-2 are included in Group #1, and the third client 3060-3 and the fourth client 3060-4 are included in Group #2. Accordingly, from the standpoint of each of the clients 3060-1 to 3060-4, a procedure similar to a procedure of removing some of the members of the group or an initialization procedure will be performed hereinafter.

In step S3003 and step S3005, each of the first client 3060-1 and the second client 3060-2 determines a reference public key for Group #1. To this end, each of the first client 3060-1 and the second client 3060-2 may determine the reference public key for Group #1 by newly generating the reference public key by using the public key of the first client 3060-1 and the public key of the second client 3060-2. Alternatively, each of the first client 3060-1 and the second client 3060-2 may determine the reference public key for Group #1 by subtracting the public key of the third client 3060-3 and the public key of the fourth client 3060-4 from the existing reference public key.

In step S3007 and step S3009, each of the third client 3060-3 and the fourth client 3060-4 determines a reference public key for Group #2. To this end, each of the third client 3060-3 and the fourth client 3060-4 may determine the reference public key for Group #2 by newly generating the reference public key by using the public key of the third client 3060-3 and the public key of the fourth client 3060-4. Alternatively, each of the third client 3060-3 and the fourth client 3060-4 may determine the reference public key for Group #2 by subtracting the public key of the first client 3060-1 and the public key of the fourth client 3060-4 from the existing reference public key.

In step S3011, step S3013, each of the first client 3060-1 and the second client 3060-2 transmits an encrypted secret key to the server 3070. Here, the secret key is encrypted by using the public key of each of the first client 3060-1 and the second client 3060-2 and then transmitted. For example, the first client 3060-1 may transmit control information or data including the secret key of the first client 3060-1 encrypted by using the public key of the first client 3060-1 and the secret key of the first client 3060-1 encrypted by using the public key of the second client 3060-2. However, if the encrypted secret keys of each of the first client 3060-1 and the second client 3060-2 provided during the initialization procedure or the key refreshing procedure are stored in the server 3070, this step may be omitted.

In step S3015, step S3017, each of the third client 3060-3 and the fourth client 3060-4 transmits an encrypted secret key to the server 3070. Here, the secret key is encrypted by using the public key of each of the third client 3060-3 and the fourth client 3060-4 and then transmitted. For example, the third client 3060-3 may transmit control information or data including the secret key of the third client 3060-3 encrypted by using the public key of the third client 3060-3 and the secret key of the third client 3060-3 encrypted by using the public key of the fourth client 3060-4. However, if the encrypted secret keys of each of the third client 3060-3 and the fourth client 3060-4 provided during the initialization procedure or the key refreshing procedure are stored in the server 3070, this step may be omitted.

In step S3019, the server 3070 determines switching keys for each group. The server 3070 may determine the switching keys for Group #1 and the switching keys for Group #2 by performing a homomorphic addition operation on at least one of the encrypted secret keys received earlier. For example, the server 3070 may determine the switching key for the first client 3060-1 belonging to Group #1 by homomorphically adding the secret key of the first client 3060-1 encrypted with the public key of the first client 3060-1 and the secret key of the second client 3060-2 encrypted with the public key of the first client 3060-1. Also, for example, the server 3070 may determine the switching key for the third client 3060-3 belonging to Group #2 by homomorphically adding the secret key of the third client 3060-3 encrypted with the public key of the third client 3060-3 and the secret key of the fourth client 3060-4 encrypted with the public key of the third client 3060-3.

By steps S3001 to S3019, the group may be divided. Accordingly, the clients 3060-1 to 3060-4 may upload data by using the new reference public keys determined in the new groups, and the server 3070 may provide data by using the new switching keys. However, since the data stored before the division of the group is encrypted by using the past reference public key, it is still processed by using the past switching keys and may be decrypted by using the past secret keys. In this case, protection of the data stored in the past may be insufficient, and therefore, it is desirable to process such that the new keys for each group may also be applied to the past data. To this end, the following steps may be performed.

In step S3021, the first client 3060-1 transmits an encrypted secret key to the server 3070. Here, the secret key is obtained by encrypting the secret key of the first client 2661-1 with the reference public key for Group #1 and then transmitted. That is, the first client 3060-1 transmits information related to the secret key encrypted by using the new reference public key.

In step S3023, the server 3070 determines a temporary switching key. The temporary switching key is a key used to change the data stored before the division of the group so as to be decryptable by using the new switching keys for Group #1. The server 3070 may determine the temporary switching key for Group #1 by performing key switching on the past switching key for the first client 3060-1 by using the past secret key encrypted with the new reference public key, which was received in step S3021, as a switching key.

In step S3025, the server 3070 performs key switching for the data belonging to Group #1. That is, the server 3070 performs data key switching. Specifically, the server 3070 may perform key switching on the data stored before the division of the group by using the temporary switching key for Group #1. As a result, the data stored before the division of the group is changed into data encrypted by using the reference public key for Group #1.

In step S3027, the third client 3060-3 transmits an encrypted secret key to the server 3070. Here, the secret key is obtained by encrypting the secret key of the third client 2661-3 with the reference public key for Group #2 and then transmitted. That is, the third client 3060-3 transmits information related to the secret key encrypted by using the new reference public key.

In step S3029, the server 3070 determines a temporary switching key. The temporary switching key is a key used to change the data stored before the division of the group so as to be decryptable by using the new switching keys for Group #2. The server 3070 may determine the temporary switching key for Group #2 by performing key switching on the past switching key for the third client 3060-3 by using the past secret key encrypted with the new reference public key, which was received in step S3027, as a switching key.

In step S3029, the server 3070 performs key switching for the data belonging to Group #2. That is, the server 3070 performs data key switching. Specifically, the server 3070 may perform key switching on the data stored before the division of the group by using the temporary switching key for Group #2. As a result, the data stored before the division of the group is changed into data encrypted by using the reference public key for Group #2.

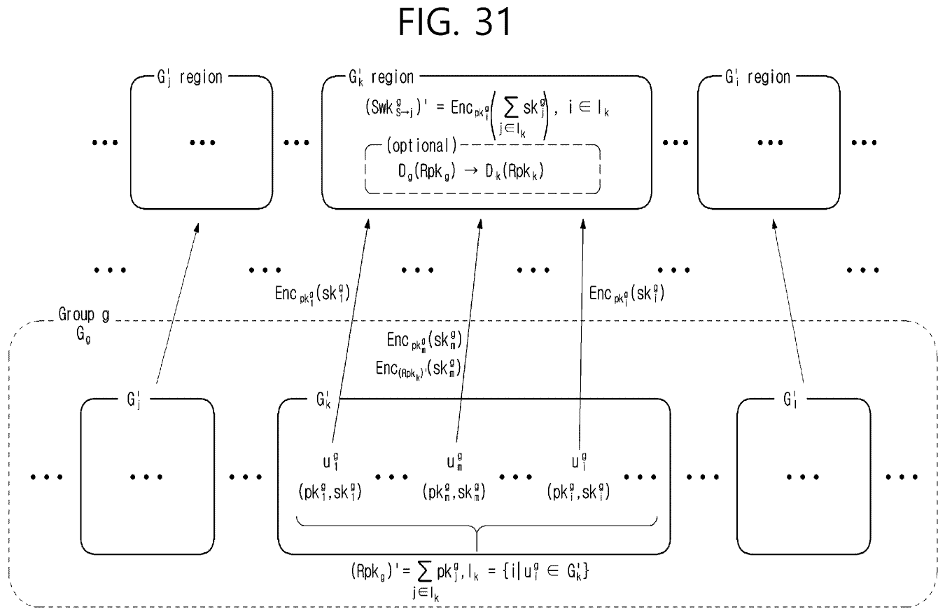

FIG. 31 shows an example of data delivered for dividing a group sharing data based on homomorphic encryption based on an embodiment of the present disclosure. Referring to FIG. 31, a situation in which a group G_{g} is divided into a plurality of groups

$${G}_{k}^{′} ( k = 1 , 2 , … )$$

is shown.

First, reference public keys are generated. Specifically, the clients belonging to the new groups

$${G}_{k}^{′} ( k = 1 , 2 , … )$$

may determine their reference public keys as shown in [Equation 22] below.

$${( {Rpk}_{k} )}^{′} = {\sum }_{j ∈ {I}_{k}} p {k}_{j}^{g} \qquad [ Equation 22 ]$$

In [Equation 22], Iₖ is,

$$\{ i \vert {u}_{i} ∈ {G}_{k}^{′} \}$$

and denotes a set including indices of clients belonging to a new group

$${G}_{k}^{′} ,$$

and (Rpkₖ)′ denotes a new reference public key.

Subsequently, switching keys are generated. Specifically, a server S receives

$${Enc}_{{pk}_{i}^{g}} ( {sk}_{j}^{g} )$$

from each client, and by performing a homomorphic addition operation, may generate a switching key. For example, the server S generates and stores a new switching key for the new groups

$${G}_{k}^{′} ( k = 1 , 2 , … )$$

as in the following [Equation 23].

$${( {Swk}_{S \to i}^{k} )}^{′} = {Enc}_{{pk}_{i}^{g}} ( {\sum }_{j ∈ {I}_{k}} {sk}_{j}^{g} ) , i ∈ {I}_{k} \qquad [ Equation 23 ]$$

In [Equation 23],

$${( {Swk}_{S \to i}^{k} )}^{′}$$

is a new switching key for an i-th client within a group

$${G}_{k}^{′}$$

from a server,

$${Enc}_{{pk}_{i}^{g}} ( \cdot )$$

is a function that encrypts using a public key of an i-th client of the group G_{g}, and

$${sk}_{j}^{g}$$

denotes a secret key of a j-th client of the group G_{g}.

And, data management is performed. A server S may perform key switching for group data stored in the group G_{g} or may keep the data without performing key switching. If the data is kept without key switching, the server S may maintain the original switching key

$${Swk}_{S \to j}^{k} , ( j = 1 , 2 , … , {N}_{g} ) .$$

When performing key switching for group data stored in the group G_{g}, the server S and a representative client

$${u}_{m}^{k}$$

perform the following operations.

A representative client

$${u}_{m}^{k}$$

belonging to each of the new groups

$${G}_{k}^{′}$$

generates

$${( {TSwk}_{k} )}^{′} = {Enc}_{{( {Rpk}_{k} )}^{′}} ( {sk}_{m}^{g} )$$

and transmits it to the server. The server, using the received (TSwkₖ)′ from the client

$${u}_{m}^{k} ,$$

may determine a temporary switching key for the group

$${G}_{k}^{′}$$

as in the following [Equation 24].

$${TSwk}_{k} = {Enc}_{{( {Rpk}_{k} )}^{′}} ( {\sum }_{j = 1}^{{N}_{g}} {sk}_{j}^{g} ) = {( {TSwk}_{k} )}^{′} \{ {Swk}_{S \to m}^{g} \} \qquad [ Equation 24 ]$$

In [Equation 24], TSwkₖ is a temporary switching key, (TSwkₖ)′ is a past secret key of a representative client encrypted using a new reference public key,

$${Swk}_{S \to m}^{g}$$

is a switching key for an m-th client within the group G_{g} from a server, (Rpk_{g})′ is a new reference public key of the group

$${G}_{k}^{′} ,$$

Enc₍ᵣₚₖ_{ₖ}₎′(⋅) is a function that encrypts based on fully homomorphic encryption with a new reference public key of the group

$${G}_{k}^{′} , and {sk}_{j}^{g}$$

denotes a secret key of a j-th client with a new reference public key of the group within the group G_{g} from a server.

The server, using the temporary switching key TSwk, may perform key switching for the data of the group G_{g} stored on the server as in the following [Equation 25].

$${𝒟}_{k} ( {Rpk}_{k} ) = TSwk \{ {𝒟}_{g} ( {Rpk}_{g} ) \} \qquad [ Equation 25 ]$$

In [Equation 25], [symbol] _{g}(Rpk_{g}) is data encrypted using a reference public key of the group G_{g}, and [symbol] ₖ(Rpkₖ) denotes data encrypted using a reference public key of the group

$${G}_{k}^{′} .$$

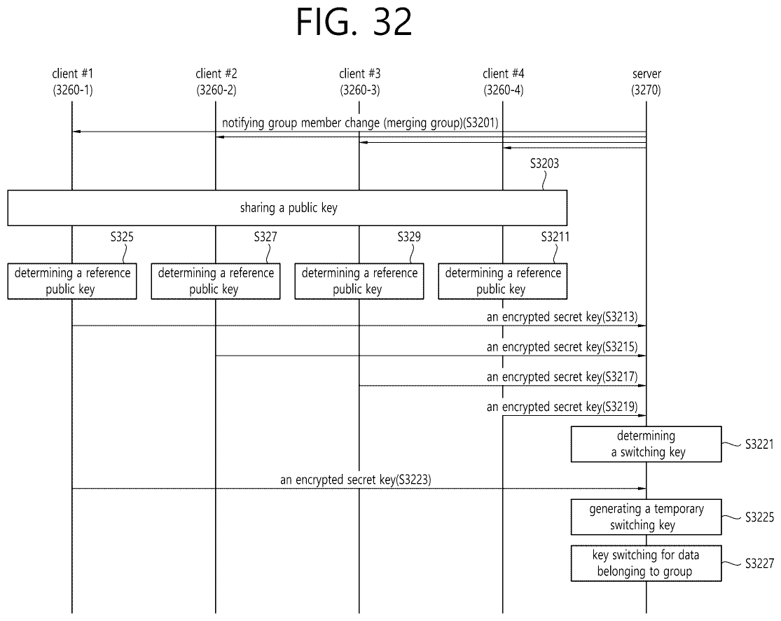

FIG. 32 shows an example of a procedure for merging groups sharing data based on homomorphic encryption based on an embodiment of the present disclosure. In FIG. 32, the first client and the second client 3260-1 belong to Group #1, and the third client 3206-3 and the fourth client 3260-4 belong to Group #2, but by the procedure described below, Group #1 and Group #2 are merged into one group. FIG. 32 shows a case where four clients 3260-1 to 3260-4 form one group, but the number of clients included in one group may be three or less or five or more.

Referring to FIG. 32, in step S3201, the server 3270 transmits a notification of the change of the group members to the members belonging to the groups. Here, the notification instructs that Group #1 and Group #2 are merged into one group. That is, the server 3270 notifies the first client to the fourth client 3260-1 to 3260-4 of the merging of the groups and provides information related to the members belonging to the counterpart group being merged. Accordingly, from the standpoint of each of the clients 3260-1 to 3260-4, a procedure similar to a procedure of adding members to the group or an initialization procedure will be performed hereinafter.

In step S3203, the clients 3260-1 to 3260-4 share public keys. Each of the clients 3260-1 to 3260-4 transmits information related to a new public key (e.g., public key, encryption parameters, etc.) to other clients and receives information related to the new public keys of the other clients. At this time, since the first client 3260-1 and the second client 3260-2 have already shared each other's public keys through the initialization procedure or the key refreshing procedure, the public key sharing operation between the first client 3260-1 and the second client 3260-2 may be omitted. For a similar reason, the public key sharing operation between the third client 3260-3 and the third client 3260-3 may be omitted. Based on another embodiment, the public keys may be shared by another method, and in this case, step S3203 may be omitted. For example, the notification transmitted in step S3201 may include the public keys of the clients 3260-1 to 3260-4, and in this case, step S3203 may be omitted.

In step S3205, step S3207, step S3209, step S3211, each of the clients 3260-1 to 3260-4 determines a reference public key. To this end, each of the clients 3260-1 to 3260-4 may determine the reference public key for the merged group by newly generating the reference public key using the public keys of the clients 3260-1 to 3260-4. Alternatively, each of the clients 3260-1 to 3260-4 may determine the reference public key for the merged group by adding the public keys of the members of the counterpart group to the existing reference public key.

In steps S3213, S3215, S3217, S3219, each of the clients 3260-1 to 3260-4 transmits an encrypted secret key to the server 3270. Here, the secret key is encrypted by using the public key of each of the clients 3260-1 to 3260-4, and then transmitted. For example, the first client 3260-1 may transmit control information or data including at least one of the secret key of the first client 3260-1 encrypted by using the public key of the first client 3260-1, the secret key of the first client 3260-1 encrypted by using the public key of the second client 3260-2, the secret key of the first client 3260-1 encrypted by using the public key of the third client 3260-3, and the secret key of the first client 3260-1 encrypted by using the public key of the fourth client 3260-4. Accordingly, ciphertexts for 16 secret keys in total, 4 for each member, are transmitted. However, if the encrypted secret key provided during an initialization procedure or a key refreshing procedure for group #1 and group #2 is stored in the server 3270, transmission of a part of the 16 ciphertexts may be omitted.

In step S3221, the server 3270 determines switching keys. The server 3270 may determine switching keys for members belonging to a merged group by performing a homomorphic addition operation on the encrypted secret keys previously received. For example, the server 3270 may determine a switching key for the first client 3260-1 by homomorphically adding the secret key of the first client 3260-1 encrypted by the public key of the first client 3260-1, the secret key of the second client 3260-2 encrypted by the public key of the first client 3260-1, the secret key of the third client 3260-3 encrypted by the public key of the first client 3260-1, and the secret key of the fourth client 3260-4 encrypted by the public key of the first client 3260-1.

A group may be merged by steps S3201 to S3221. Accordingly, the clients 3260-1 to 3260-4 upload data by using a new reference public key, and the server 3270 may provide data by using a new switching key. However, since the data stored before the merging of the group is encrypted by using the reference public key for the past group #1 or group #2, the data is still processed by using the past switching key and may be decrypted by using the past secret key. In this case, utilization of the data stored in the past may be insufficient, and thus it is desirable to process such that the new keys for the merged group may also be applied to the past data. To this end, the following steps may be performed.

In step S3223, the first client 3260-1 transmits an encrypted secret key to the server 3270. Here, the secret key is encrypted by using the reference public key for the merged group for the secret key of the first client 3260-1, and then transmitted. That is, the first client 3260-1 transmits information related to the secret key encrypted by using the new reference public key.

In step S3225, the server 3270 determines a temporary switching key. The temporary switching key is a key used to change data stored before the division of the group so as to be decryptable by using a new switching key for the merged group. The server 3270 may determine the temporary switching key for the merged group by key-switching the past switching key for the first client 3260-1 by using, as a switching key, the past secret key encrypted by using the new reference public key received in step S3221.

In step S3227, the server 3270 performs key switching for data belonging to the merged group. That is, the server 3270 performs data key switching. Specifically, the server 3270 may key-switch data stored before the division of the group by using the temporary switching key for the merged group. As a result, the data stored before the division of the group is changed into data encrypted by using the reference public key for the merged group.

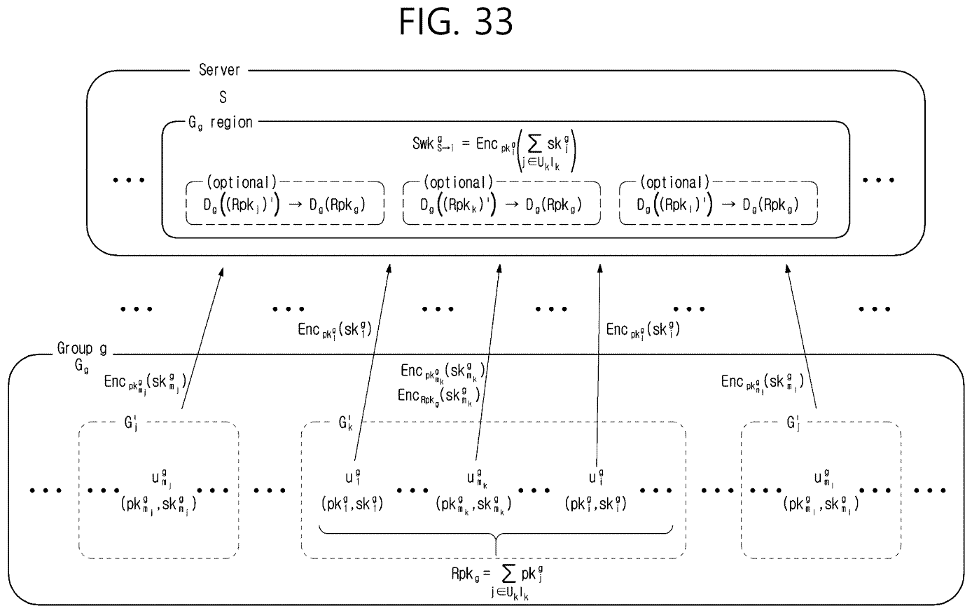

FIG. 33 shows an example of data transmitted for merging groups that share data based on homomorphic encryption based on an embodiment of the present disclosure. Referring to FIG. 33, a situation in which several groups

$${G}_{k}^{′} , ( k = 1 , 2 , … )$$

are merged into a single group G_{g} is exemplified. Similar to the division of groups, in the following description, Iₖ is defined as a set including indices of clients belonging to

$${G}_{k}^{′} .$$

The index of UₖIₖ is expressed as a reference index of the group G_{g}.

First, a reference public key is determined. Specifically, the clients belonging to the new group G_{g} may generate the reference public key as shown in [Equation 26] below.

$${Rpk}_{g} = {\sum }_{j ∈ {U}_{k} {I}_{k}} {pk}_{j}^{g} \qquad [ Equation 26 ]$$

In [Equation 26], Rpk_{g} is a reference public key of the group G_{g}, and

$${pk}_{j}^{g}$$

denotes a j-th public key of the group G_{g}.

Subsequently, switching keys are determined. Specifically, the server receives

$${Enc}_{{pk}_{i}^{g}} ( {sk}_{j}^{g} )$$

from all clients

$${u}_{i}^{g} ,$$

and using a homomorphic addition operation, may generate a switching key as in the following [Equation 27].

$${Swk}_{S \to i}^{g} = {Enc}_{{pk}_{i}^{g}} ( {\sum }_{j ∈ {⋃}_{k} {I}_{k}} {sk}_{j}^{g} ) \qquad [ Equation 27 ]$$

In [Equation 27],

$${Swk}_{S \to i}^{g}$$

is a new switching key for an i-th client within the group G_{g} from a server,

$${Enc}_{{pk}_{i}^{g}} ( \cdot )$$

is a function that encrypts using a public key of the i-th client, and

$${sk}_{j}^{g}$$

denotes a secret key of a j-th client of the group G_{g}.

Subsequently, data management is performed. Specifically, a server may perform key switching for group data stored in the group G_{g}, or may keep the data without key switching. If the data is kept without key switching, the server may maintain the original switching key

$${Swk}_{S \to j}^{g} ( j = 1 , 2 , … , {N}_{g} ) .$$

When key switching is performed for group data stored in the group G_{g}, the server performs the following operations.

When key switching for data is performed, a representative client

$${u}_{m}^{k}$$

belonging to the group

$${G}_{k}^{′}$$

transmits

$${( {TSwk}_{k} )}^{′} = {Enc}_{{Rpk}_{g}} ( {( {sk}_{m}^{k} )}^{′} )$$

to the server. The server, using the existing group transmits switching key, generates a temporary switching key based on

$${( {Swk}_{S \to m}^{k} )}^{′} = {Enc}_{{pk}_{m}^{k}} ( {\sum }_{j ∈ {I}_{k}} {( {sk}_{j}^{k} )}^{′} ) .$$

The temporary switching key may be determined as in the following [Equation 28].

$${TSwk}_{k} = {( {TSwk}_{k} )}^{′} \{ ( {Swk}_{S \to m}^{k} ) \} = {Enc}_{{Rpk}_{g}} ( {\sum }_{j ∈ {I}_{k}} {( {sk}_{k}^{k} )}^{′} ) \qquad [ Equation 28 ]$$

In [Equation 28], TSwk is a temporary switching key, (TSwk)′ is a secret key of a representative client encrypted using a reference public key of the group G_{g}

$${Swk}_{S \to m}^{k}$$

is a switching key for an m-th client within the group

$${G}_{k}^{′}$$

from a server, Rpk_{g} is a reference public key of the group G_{g}, Enc_{Rpk}_{_{g}}(⋅) is a function that encrypts based on fully homomorphic encryption with a new reference public key of the group

$${G}_{k}^{′} , and {( {sk}_{j}^{k} )}^{′}$$

denotes a secret key of a j-th client within the pre-merged group

$${G}_{k}^{′} .$$

The server may perform key switching for data of group G_{g} stored in the server by using a temporary switching key TSwkₖ. The key switching may be performed as shown in [Equation 29] below.

$${𝒟}_{g} ( {Rpk}_{g} ) = {TSwk}_{k} \{ {𝒟}_{k} ( {( {Rpk}_{k} )}^{′} ) \} \qquad [ Equation 29 ]$$

In [Equation 29], [symbol] _{g}(Rpk_{g}) is data encrypted using a reference public key of the group G_{g}, TSwkₖ is a temporary switching key for data of the group

$${G}_{k}^{′} ,$$

and [symbol] ₖ((Rpkₖ)′) denotes data encrypted using a reference public key of the pre-merged group

$${G}_{k}^{′} .$$

Based on the various embodiments described above, in a communication situation among edge devices such as an IoT system, etc., when the server stores and processes states and specific information of each edge device group, information of each edge device may not be obtained by the server, and thus robust security may be guaranteed. Also, the proposed technique may guarantee robustness against threats of data information exposure by an attacker to the server's edge device information.

Also, based on various embodiments, in that secret keys of each user in the group are not shared, security of each member may be further enhanced. Also, by performing key refreshing using a key switching technique of homomorphic encryption, higher security than before may be secured, and an advantage arises that a high degree of freedom exists for changes in the number of members in the group and for merging or dividing between groups. In particular, when a key is changed, since data decryptable by using the changed key may be secured only by key switching at the server without a need to re-encrypt and provide the existing data stored in the server, the proposed technology may have high utility in terms of communication efficiency and data management.

Examples of the above-described proposed methods may be included as one of the implementation methods of the present disclosure and thus may be regarded as kinds of proposed methods. In addition, the above-described proposed methods may be independently implemented or some of the proposed methods may be combined (or merged). The rule may be defined such that the base station informs the UE of information on whether to apply the proposed methods (or information on the rules of the proposed methods) through a predefined signal (e.g., a physical layer signal or a higher layer signal).

Those skilled in the art will appreciate that the present disclosure may be carried out in other specific ways than those set forth herein without departing from the spirit and essential characteristics of the present disclosure. The above exemplary embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein. Moreover, it will be apparent that some claims referring to specific claims may be combined with another claims referring to the other claims other than the specific claims to constitute the embodiment or add new claims by means of amendment after the application is filed.

### INDUSTRIAL AVAILABILITY

The embodiment(s) of the present disclosure are applicable to various radio access systems. Examples of the various radio access systems include a 3rd generation partnership project (3GPP) or 3GPP2 system.

The embodiment(s) of the present disclosure are applicable not only to the various radio access systems but also to all technical fields, to which the various radio access systems are applied. Further, the proposed methods are applicable to mmWave and THzWave communication systems using ultrahigh frequency bands.

Additionally, the embodiment(s) of the present disclosure are applicable to various applications such as autonomous vehicles, drones and the like.

1. A method, comprising:
receiving, by a first device from a second device, a first message requesting capability information of the first device;
transmitting, by the first device to the second device, a second message including the capability information of the first device;
performing, by the first device, control signaling with the second device; and
transmitting, by the first device, data based on the control signaling,
wherein the data or a message transmitted through the control signaling, as information for a key refreshing procedure for a data sharing service based on homomorphic encryption, includes a secret key of the first device encrypted by using a first reference public key based on public keys of updated members and is used to convert data encrypted by using a second reference public key determined before the key refreshing procedure into data encrypted by using the first reference public key.

2. The method of claim 1, wherein the key refreshing procedure is a procedure of updating secret keys and public keys of members in a group sharing data based on the data sharing service,
wherein the updating of the secret keys and the public keys causes updating of a reference public key and conversion of data stored in the second device, and
wherein the data is converted, without re-uploading, by using the encrypted secret key of the first device.

3. The method of claim 1, wherein the encrypted secret key of the first device is determined by encrypting a secret key determined before the key refreshing procedure by using the first reference public key.

4. The method of claim 1, wherein the data or the message through the control signaling includes, during an initialization procedure of the data sharing service, a secret key of the first device encrypted by using public keys of members of a group sharing data.

5. The method of claim 1, wherein the data includes, during an upload procedure of the data sharing service, data encrypted by using a reference public key determined based on public keys of members of a group sharing data and a tag for the encrypted data.

6. The method of claim 1, wherein the data or the message through the control signaling includes, during a member change procedure in which the first device is removed from a group sharing data, a secret key of the first device encrypted by using public keys of other members of the group except the first device.

7. The method of claim 1, wherein the data or the message through the control signaling includes, during a member change procedure in which a third device is added to a group sharing data, a secret key of the first device encrypted by using public keys of the third device.

8. The method of claim 1, wherein the second message indicates that the first device supports encryption based on the homomorphic encryption.

9. A method, comprising:
transmitting, by a second device to a first device, a first message requesting capability information of the first device;
receiving, by the second device from the first device, a second message including the capability information of the first device;
performing, by the second device, control signaling with the first device; and
receiving, by the second device, data from the first device based on the control signaling,
wherein the data or a message received through the control signaling, as information for a key refreshing procedure for a data sharing service based on homomorphic encryption, includes a secret key of the first device encrypted by using a first reference public key based on public keys of updated members and is used to convert data encrypted by using a second reference public key determined before the key refreshing procedure into data encrypted by using the first reference public key.

10. The method of claim 9, further comprising:
determining a temporary switching key by performing key switching for a switching key for the first device by using, as the switching key, the secret key of the first device encrypted by using the first reference public key; and
converting the data encrypted by using the second reference public key into the data encrypted by using the first reference public key by performing key switching for the data encrypted by using the second reference public key by using the temporary switching key.

11. The method of claim 9, further comprising:
determining switching keys for each of the members based on at least one secret key of at least one member other than the first device and a secret key of the first device encrypted by using public keys of members of a group sharing data.

12. The method of claim 9, further comprising:
checking a tag received for download from the first device;
checking shared data indicated by the tag;
performing key switching for the shared data by using a switching key for the first device; and
transmitting the key-switched data to the first device.

13. The method of claim 9, further comprising:
when a change occurs in members of a group sharing data, transmitting a message notifying the change to the first device,
wherein the message includes information related to an added member or a removed member.

14. The method of claim 9, wherein the second message indicates that the first device supports encryption based on the homomorphic encryption.

15. A first device, comprising:
at least one transceiver;
at least one processor; and
at least one memory connected to the at least one processor and storing instructions that, based on being executed, cause the first device to perform operations comprising:
receiving, from a second device, a first message requesting capability information of the first device;
transmitting, to the second device, a second message including the capability information of the first device;
performing control signaling with the second device; and
transmitting data based on the control signaling,
wherein the data or a message transmitted through the control signaling, as information for a key refreshing procedure for a data sharing service based on homomorphic encryption, includes a secret key of the first device encrypted by using a first reference public key based on public keys of updated members and is used to convert data encrypted by using a second reference public key determined before the key refreshing procedure into data encrypted by using the first reference public key.

16-18. (canceled)
